(19) United States
(12) Patent Application Publication
(10) Pub. No.: US 2023/0164609 A1
(43) Pub. Date: May 25, 2023

(54) MEASUREMENT IDENTITIES COORDINATION BETWEEN MASTER NODE AND SECONDARY NODE

(71) Applicant: Telefonaktiebolaget LM Ericsson (publ), Stockholm (SE)

(72) Inventor: Antonino Orsino, KIRKKONUMMI (FI)

(21) Appl. No.: 17/917,703

(22) PCT Filed: Mar. 24, 2021
(86) PCT No.: PCT/IB2021/052451

§ 371 Date: Oct. 7, 2022

Related U.S. Application Data
(60) Provisional application No. 63/007,904, filed on Apr. 9, 2020.

(51) Int. Cl. H04W 24/10; H04W 76/30

(52) U.S. Cl. CPC H04W 24/10; H04W 76/30

(57) ABSTRACT

A method performed by a secondary node is provided. The method includes coordinating a number of measurement identities exchanged with a master node. The coordinating includes at least one of the following: signaling a request to the master node for a new value for a maximum number of measurement identities that the secondary node can configure when the secondary node wants to allocate additional measurement identities in excess of a prior number of measurement identities configured by the master node; and subsequent to receiving from the master node the new value for the maximum number of measurement identities and wherein the secondary node previously configured the measurement identities based on a prior value for the maximum number measurement identities, releasing a number of the measurement identities to comply with the new value.

### TECHNICAL FIELD

The present disclosure relates generally to communications, and more particularly to communication methods and related devices and nodes supporting wireless communications.

### BACKGROUND

In 3GPP, a dual-connectivity (DC) solution has been specified, both for Long Term Evolution (LTE) and between LTE and new radio (NR). In DC, two nodes are involved, a master node (MN or MeNB) and a Secondary Node (SN, or SeNB). Multi-connectivity (MC) is a case when there are more than two nodes involved. Also, it has been proposed in 3GPP that DC is used in Ultra Reliable Low Latency Communications (URLLC) cases in order to enhance robustness and avoid connection interruptions.

3GPP dual connectivity will now be discussed.

There are different ways to deploy a 5G network with or without interworking with LTE (also referred to as E-UTRA) and evolved packet core (EPC), as depicted in FIG. 1. In principle, NR and LTE can be deployed without any interworking, denoted by NR stand-alone (SA) operation, that is a gNodeB (gNB) in NR can be connected to a fifth generation (5G) core network (5GC) and an eNodeB (eNB) can be connected to EPC with no interconnection between the two (Option 1 and Option 2 in FIG. 1). On the other hand, the first supported version of NR, which may referred to as EN-DC (E-UTRAN-NR Dual Connectivity), is illustrated by Option 3 in FIG. 1. In such a deployment, dual connectivity between NR and LTE is applied with LTE as the master and NR as the secondary node. The RAN node (gNB) supporting NR, may not have a control plane connection to core network (EPC), instead it relies on the LTE as master node (MeNB). This can be referred to as “Non-standalone NR”. It is noted that in this case the functionality of a NR cell is limited and can be used for connected mode user equipments (UEs) as a booster and/or diversity leg, but an RRC_IDLE UE cannot camp on these NR cells.

With introduction of 5GC, other options may be also valid. As mentioned above, Option 2 of FIG. 1 supports stand-alone NR deployment where gNB is connected to 5GC. Similarly, LTE can also be connected to 5GC using Option 5 in FIG. 1 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes). It is noted that, Option 4 and Option 7 of FIG. 1 are other variants of dual connectivity between LTE and NR which will be standardized as part of NG-RAN connected to 5GC, denoted by MR-DC (Multi-Radio Dual Connectivity). The MR-DC umbrella includes:
EN-DC (Option 3 in FIG. 1): LTE is the master node and NR is the secondary (EPC CN employed);
NE-DC (Option 4 in FIG. 1): NR is the master node and LTE is the secondary (5GCN employed);
NGEN-DC (Option 7 in FIG. 1): LTE is the master node and NR is the secondary (5GCN employed); and
NR-DC (variant of Option 2 in FIG. 1): Dual connectivity where both the master and secondary are NR (5GCN employed).

As migration for these options may differ from different operators, it is possible to have deployments with multiple options in parallel in the same network e.g., there could be an eNB base station supporting Option 3, 5 and 7 in FIG. 1 in the same network as a NR base station supporting Options 2 and 4 in FIG. 1. In combination with dual connectivity solutions between LTE and NR it is also possible to support CA (Carrier Aggregation) in each cell group (e.g., master cell group (MCG) and secondary cell group (SCG)) and dual connectivity between nodes on same radio access technology (RAT) (e.g., NR-NR DC). For the LTE cells, a consequence of these different deployments is the co-existence of LTE cells associated to eNBs connected to EPC, 5GC or both EPC/5GC.

As discussed above, DC is standardized for both LTE and E-UTRA-NR DC (EN-DC).

LTE DC and EN-DC are designed differently when it comes to which nodes control what. Two options include:
1. A centralized solution (e.g., LTE-DC), and
2. A decentralized solution (e.g., EN-DC).

FIG. 2 illustrates a schematic control plane architecture for LTE DC and EN-DC. A main difference here is that in EN-DC, the SN has a separate radio resource control (RRC) entity (NR RRC). This means that the SN can also control the UE; sometimes without the knowledge of the MN, but the SN may need to coordinate with the MN. In LTE-DC, the RRC decisions come from the MN (MN to UE). It is noted, however, that the SN still decides the configuration of the SN because it is only the SN itself that has knowledge of what kind of resources, capabilities etc. the SN has.

For EN-DC, some changes compared to LTE DC include:
The introduction of split bearer from the SN (referred to as SCG split bearer);
The introduction of split bearer for RRC; and
The introduction of a direct RRC from the SN (also referred to as SCG SRB).

FIGS. 3 and 4 illustrate User Plane (UP) and Control Plane (CP) architectures for EN-DC. Referring to FIG. 3, FIG. 3 illustrates network side protocol termination options for MCG, SCG and split bearers in MR-DC with EPC (EN-DC). Referring to FIG. 4, FIG. 4 illustrates, a network architecture for a control plane in EN-DC.

A SN is sometimes referred to as SgNB (where gNB is a NR base station); and a MN is sometimes referred to as MeNB in case LTE is the master node and NR is the secondary node. In another case where NR is the master node and LTE is the secondary node, the corresponding terms include MgNB and SeNB.

Split RRC messages may be used for creating diversity, and the sender can decide to either choose one of the links for scheduling the RRC messages, or it can duplicate the message over both links. In the downlink, the path switching between the MCG or SCG legs or duplication on both is left to network implementation. On the other hand, for the UL, the network configures the UE to use the MCG, SCG or both legs. The terms “leg”, “path” and “RLC bearer” are used interchangeably herein.

### SUMMARY

According to some embodiments, a method performed by a secondary node is provided. The method includes coordinating a number of measurement identities exchanged with a master node. The coordinating includes at least one of the following: signaling a request to the master node for a new value for a maximum number of measurement identities that the secondary node can configure when the secondary node wants to allocate additional measurement identities in excess of a prior number of measurement identities configured by the master node; and subsequent to receiving from the master node the new value for the maximum number of measurement identities and wherein the secondary node previously configured the measurement identities based on a prior value for the maximum number measurement identities, releasing a number of the measurement identities to comply with the new value.

In some embodiments, the method can further include receiving an acknowledgement from the master node of the new value for a maximum number of measurement identities. The method can further include, responsive to the acknowledgement, changing a secondary cell group based on applying the new value to a secondary cell group configuration to meet a capability of a communication device.

In some embodiments, the secondary node can already have the prior number of measurement identities configured by the master node, and the method can further include receiving from the master node the new value for the maximum number of measurement identities. The method can further include, responsive to the receiving, signaling a response to the master node that the new value is rejected.

In some embodiments, the method can further include receiving from the master node the new value for the maximum number of measurement identities. The method can further include, responsive to the receiving, signaling a response to the master node with an identification of the measurement identities that are not allocated by the secondary node.

In some embodiments, the method can further include receiving from the master node the new value for the maximum number of measurement identities. The method can further include, responsive to the receiving, signaling a response to the master node with the number of the requested measurement identities. The method can further include releasing a number of configured measurement identities to meet the new value from the master node.

In some embodiments, the method can further include, subsequent to signaling the request, triggering a secondary node modification procedure.

In some embodiments, the method can further include, subsequent to signaling the request, triggering a dual connectivity procedure that involves the change of the secondary cell group configuration.

According to other embodiments, a method performed by a master node is provided. The method includes coordinating a number of measurement identities exchanged with a secondary node. The coordinating includes receiving a request from the secondary node for a new value for a maximum number of measurement identities that the secondary node can configure when the secondary node wants to allocate additional measurement identities in excess of a prior number of measurement identities configured by the master node. The method can further include, responsive to the request, performing at least one of the following: ignoring the request if no measurement identities are available; and signaling a response to the secondary node comprising the new value for the maximum number of measurement identities and releasing a number of the measurement identities to comply with the new value.

In some embodiments, the method can further include signaling an acknowledgement to the secondary node of the new value for a maximum number of measurement identities. The method can further include, subsequent to signaling the acknowledgement, changing a master cell group based on applying the new value to the a configuration of the master cell group to meet a capability of a communication device.

In some embodiments, the secondary node can already have the prior number of measurement identities configured by the master node, and the method can further include signaling to the secondary node the new value for the maximum number of measurement identities. The method can further include receiving a response from the secondary node that the new value is rejected.

In some embodiments, the method can further include signaling to the secondary node the new value for the maximum number of measurement identities. The method can further include receiving a response from the secondary node with an identification of the measurement identities that are not allocated by the secondary node.

In some embodiments, the method can further include signaling to the secondary node the new value for the maximum number of measurement identities. The method can further include receiving a response from the secondary node with the number of the requested measurement identities. The method can further include releasing a number of configured measurement identities to meet the new value.

In some embodiments, the method can further include, subsequent to the signaling of a new value for the maximum number of measurement identities to the secondary node, triggering a secondary node modification procedure.

In some embodiments, the method can further include, subsequent to signaling of a new value for the maximum number of measurement identities to the secondary node, triggering a dual connectivity procedure that involves the change of a secondary cell group configuration.

Corresponding embodiments of inventive concepts for a secondary node, a master node, computer products, and computer programs are also provided.

In some approaches, a maximum number of measurement identities supported by a user equipment (UE) may not be efficiently shared between a master node (MN) and a secondary node (SN). Such approaches may lead to a degradation of the performance or wrong network behavior under particular circumstances. Further, since coordination between the MN and SN may not be optimal, such approaches may not result in UE capabilities not being exceeded. Thus, a RRC reestablishment and to a drop of the connectivity for several seconds may occur.

Potential advantages provided by various embodiments of the present disclosure may include that a number of measurement identities supported by the UE (e.g., a maximum number) may be efficiently shared between the MN and SN. As a consequence, a degradation of the performance or incorrect network behavior under particular circumstances may be avoided. Further, coordination between the MN and SN may become optimal or improved. As a consequence, UE capabilities may not be exceeded and, thus, a RRC reestablishment procedure with a drop of the connectivity for several seconds may be avoided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a diagram illustrating LTE and NR interworking options;

FIG. 2 is a diagram illustrating an example of control plane architecture for dual connectivity in LTE DC and EN-DC;

FIG. 3 is a diagram illustrating an example of network side termination options for master cell group, secondary cell group and split bearers in MR-DC with EPC (EN-DC);

FIG. 4 is a block diagram illustrating an example of a network architecture for control plane in EN-DC;

FIG. 5 is a block diagram illustrating a communication device according to some embodiments of the present disclosure;

FIG. 6 is a block diagram illustrating a secondary node according to some embodiments of the present disclosure;

FIG. 7 is a block diagram illustrating a master node according to some embodiments of the present disclosure;

FIGS. 8A-8B are flow charts illustrating examples of operations of a secondary node according to some embodiments of the present disclosure;

FIGS. 9A-9B are flow charts illustrating examples of operations of a master node according to some embodiments of the present disclosure; and

FIG. 10 is a block diagram of a wireless network in accordance with some embodiments.

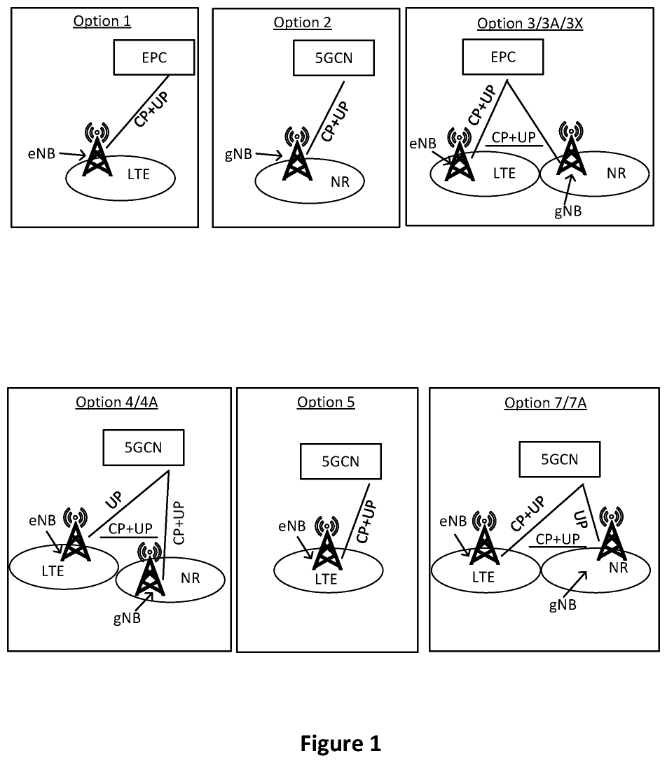

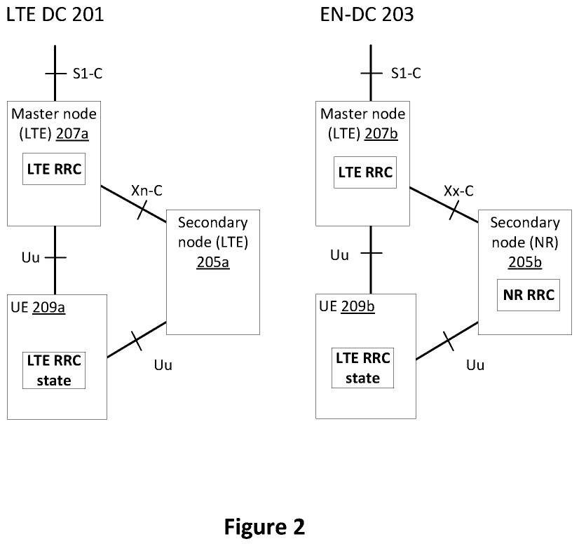

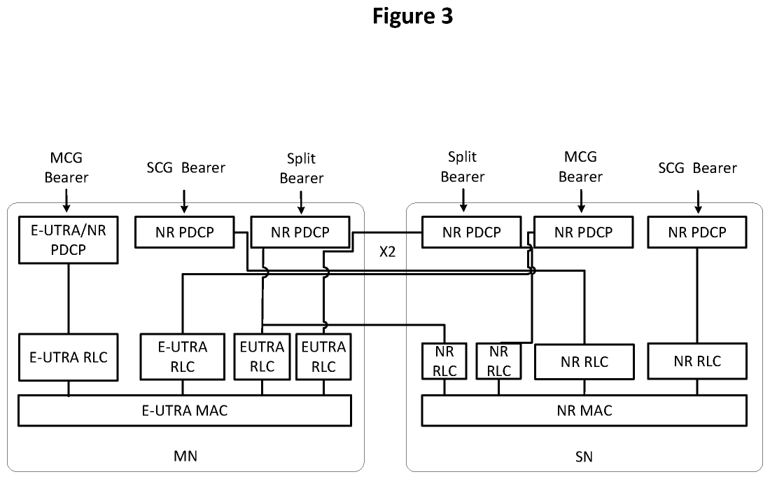

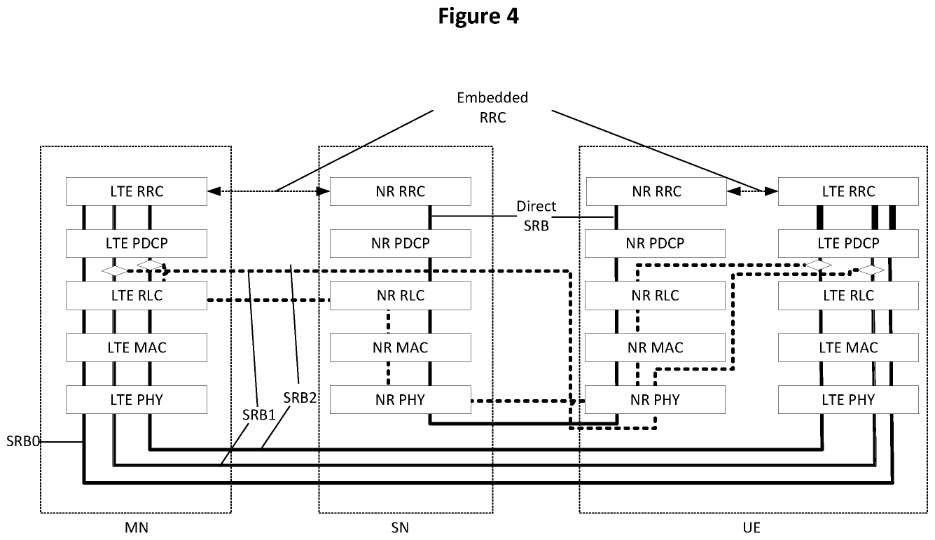

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

User equipment (UE) requirements for capabilities of measurement reporting criteria (in SA and NSA) will now be discussed.

As used herein, the term UE refers to a device capable, configured, arranged and/or operable to communicate wirelessly with network nodes and/or other wireless devices. Unless otherwise noted, the term UE may be used interchangeably herein with user equipment (UE) and/or communication device. Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the radio communication network. Examples of a UE include, but are not limited to, a smart phone, a mobile phone, a cell phone, a voice over IP (VoIP) phone, a wireless local loop phone, a desktop computer, a personal digital assistant (PDA), a wireless camera, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A UE may support device-to-device (D2D) communication, for example by implementing a 3GPP standard for sidelink communication, and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as a machine-type communication (MTC) device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

As used herein, node (e.g., secondary node and/or master node) refers to equipment capable, configured, arranged and/or operable to communicate directly or indirectly with a user equipment and/or with other network nodes or equipment in the radio communication network to enable and/or provide wireless access to the user equipment and/or to perform other functions (e.g., administration) in the radio communication network. Examples of nodes include, but are not limited to, base stations (BSs) (e.g., radio base stations, Node Bs, evolved Node Bs (eNBs), gNode Bs (including, e.g., CU107 and DUs 105 of a gNode B (gNB), etc.). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a node may be a virtual network node.

In the 3GPP RAN2 #109e meeting, it was agreed to introduce a new signaling in the inter-node RRC message in order to allow the MN and SN to coordinate about the maximum number of measurement identities so that the capability of the UE is not exceeded. This new signaling is used in all the MR-DC option.

According to the 3GPP TS 38.133 v16.2.0 specification, the UE is required to support a maximum number of reporting criteria that is defined in the following sections of 3GPP TS 38.133 v16.2.0, as follows:

### 9.1.4 Capabilities for Support of Event Triggering and Reporting Criteria

### 9.1.4.1 Introduction

This clause contains requirements on UE capabilities for support of event triggering and reporting criteria. As long as the measurement configuration does not exceed the requirements stated in clause 9.1.4.2, the UE shall meet all other performance requirements defined in clause 9 and clause 10.

The UE can be requested to make measurements under different measurement identities defined in TS 38.331 [2]. Each measurement identity corresponds to either event based reporting, periodic reporting, or no reporting. In case of event based reporting, each measurement identity is associated with an event triggering criterion. In case of periodic reporting, a measurement identity is associated with one periodic reporting criterion. In case of no reporting, a measurement identity is associated with one no reporting criterion.

The purpose of this clause is to set some limits on the number of different event triggering, periodic, and no reporting criteria the UE may be requested to track in parallel.

### 9.1.4.2 Requirements

In this clause a reporting criterion corresponds to either one event (in the case of event based reporting), or one periodic reporting criterion (in case of periodic reporting), or one no reporting criterion (in case of no reporting). For event based reporting, each instance of event, with the same or different event identities, is counted as separate reporting criterion in Table 9.1.4.2-1. The UE shall be able to support in parallel per category up to E_{cat} reporting criteria configured by PSCell and E-UTRA PCell according to Table 9.1.4.2-1. For the measurement categories belonging to intra-frequency, inter-frequency, and inter-RAT measurements (i.e., without counting other categories that the UE shall always support in parallel), the UE need not support more than the total number of reporting criteria as follows:
For UE configured with EN-DC: E_{cat,EN-DC,NR}+E_{cat,EN-DC,E-UTRA}, where E_{cat,EN-DC,NR}=10+9×n is the total number of NR reporting criteria applicable for UE configured with EN-DC according to Table 9.1.4.2-1, and n is the number of configured NR serving frequencies, including PSCell and SCells carrier frequencies, E_{cat,EN-DC,E-UTRA} is the total number of E-UTRA reporting criteria configured by E-UTRA PCell except PSCell and SCells carrier frequencies, as specified in TS 36.133 [15] for UE configured with EN-DC.
For UE configured with NE-DC: E_{cat,NE-DC,NR}+E_{cat,NE-DC,E-UTRA}, where E_{cat,NE-DC,NR}=10+9×n is the total number of NR reporting criteria according to Table 9.1.4.2-1, and n is the number of configured NR serving frequencies, including PCell and SCells carrier frequencies,
E_{cat,NE-DC,E-UTRA}=E_{cat,NE-DC,E-UTRA,inter-RAT} E_{cat,NE-DC,E-UTRA,intra-RAT}, where E_{cat,NE-DC,E-UTRA,inter-RAT} is the total number of inter-RAT E-UTRA reporting criteria configured by PCell except E-UTRA PSCell and E-UTRA SCells carrier frequencies, according to Table 9.1.4.2-1,
E_{cat,NE-DC,E-UTRA,intra-RAT} is the total number of E-UTRA reporting criteria including E-UTRA PSCell and E-UTRA SCells carrier frequencies as specified in TS 36.133 [15] for UE configured with NE-DC.
For UE configured with SA operation mode: E_{cat,SA,NR}+E_{cat,SA,E-UTRA}, where E_{cat,SA,NR}=10+9×n is the total number of NR reporting criteria according to Table 9.1.4.2-1, and n is the number of configured NR serving frequencies, including PCell, and SCells carrier frequencies,
E_{cat,SA,E-UTRA} is the total number of inter-RAT E-UTRA reporting criteria according to Table 9.1.4.2-1.
For UE configured with NR-DC: E_{cat,NR-DC,NR}+E_{cat,NR-DC,E-UT RA}, where E_{cat,NR-DC,NR}=10+9×n is the total number of NR reporting criteria according to Table 9.1.4.2-1, and n is the number of configured NR serving frequencies, including PCell, PSCell and SCells carrier frequencies,
E_{cat,NR-DC,E-UTRA} is the total number of inter-RAT E-UTRA reporting criteria according to Table 9.1.4.2-1.

TABLE 9.1.4.2-1
Requirements for reporting criteria per measurement category

| Measurement category | E_{cat} | Note |
|---|---|---|
| Intra-frequency^{Note 1,2,3,4,5} | 9 | Events for any one or a combination of |
| | | intra-frequency SS-RSRP, SS-RSRQ, |
| | | and SS-SINR for NG-RAN intra- |
| | | frequency cells |
| Inter-frequency^{Note 2,3,4,5} | 10 | Events for any one or a combination of |
| | | inter-frequency SS-RSRP, SS-RSRQ, |
| | | and SS-SINR for NG-RAN inter- |
| | | frequency cells |
| Inter-RAT (E-UTRA FDD, E-UTRA TDD)^{Note 2,4,5} | 10 | Only applicable for UE with this (inter- |
| | | RAT) capability. These reporting |
| | | criteria apply for any E-UTRA carrier |
| | | frequencies other than the carrier |
| | | frequency of the E-UTRA PSCell or E- |
| | | UTRA SCell. |
| Inter-RAT (E-UTRA FDD, E-UTRA TDD) | 1 | Inter-RAT RSTD measurement |
| RSTD^{Note 2,4,5} | | reporting for UE supporting OTDOA; 1 |
| | | report capable of minimum 16 inter- |
| | | RAT cell measurements. |
| | | Only applicable for UE with this (inter- |
| | | RAT RSTD via LPP [22]) capability. |
| | | These reporting criteria apply for any E- |
| | | UTRA carrier frequencies other than the |
| | | carrier frequency of the E-UTRA PSCell |
| | | or E-UTRA SCell. |
| Inter-RAT (E-UTRA FDD, E-UTRA TDD) | 1 | Inter-RAT RSRP and RSRQ |
| RSRP and RSRQ measurements for E-CID^{Note 2,4,5} | | measurements for E-CID reported to E- |
| | | SMLC via LPP [22]. One report capable |
| | | of at least in total 10 inter-RAT RSRP |
| | | and RSRQ measurements. Applicable to |
| | | UE capable of reporting inter-RAT |
| | | RSRP and RSRQ to E-SMLC via LPP. |
| | | These reporting criteria apply for any E- |
| | | UTRA carrier frequencies other than the |
| | | carrier frequency of the E-UTRA PSCell |
| | | or E-UTRA SCell. |

NOTE 1:
When the UE is configured with PSCell and SCell carrier frequencies, E_{cat} for Intra-frequency is applied per corresponding NR serving frequency.
NOTE 2:
Applicable for UE configured with SA NR operation mode.
NOTE 3:
Applicable for UE configured with EN-DC operation mode.
NOTE 4:
Applicable for UE configured with NE-DC operation mode.
NOTE 5:
Applicable for UE configured with NR-DC operation mode.

Sections of 3GPP TS 36.133 v16.2.0, provide as follows:

### 8.2 Capabilities for Support of Event Triggering and Reporting Criteria

### 8.2.1 Introduction

This clause contains requirements on UE capabilities for support of event triggering and reporting criteria. As long as the measurement configuration does not exceed the requirements stated in clause 8.2.2, the UE shall meet the performance requirements defined in clause 9. The UE can be requested to make measurements under different measurement identities defined in TS 36.331 [2]. Each measurement identity corresponds to either event based reporting, periodic reporting, logged measurement reporting [2] or no reporting. In case of event based reporting, each measurement identity is associated with an event. In case of periodic reporting, a measurement identity is associated with one periodic reporting criterion. In case of logged measurement reporting, a measurement identity is associated with one logged measurement reporting criterion. In case of no reporting, a measurement identity is associated with one no reporting criterion. The purpose of this clause is to set some limits on the number of different event, periodic, logged measurement and no reporting criteria the UE may be requested to track in parallel.

### 8.2.2 Requirements

In this clause a reporting criterion corresponds to either one event (in the case of event based reporting), or one periodic reporting criterion (in case of periodic reporting), or one logged measurement reporting criterion (in case of logged measurement reporting), or one no reporting criterion (in case of no reporting). For event based reporting, each instance of event, with the same or different event identities, is counted as separate reporting criterion in table 8.2.2-1. The UE shall be able to support in parallel per category up to E_{cat} reporting criteria according to table 8.2.2-1. For the measurement categories belonging to measurements on: E-UTRA intra-frequency cells, E-UTRA inter-frequency cells, and inter-RAT per supported RAT (i.e. without counting other categories that the UE shall always support in parallel), the UE need not support more than the total number of reporting criteria as follows:
26 reporting criteria in total if the UE is not configured with any SCell or PSCell carrier frequency,
35 reporting criteria in total if the UE is configured with one SCell carrier frequency,
44 reporting criteria in total if the UE is configured with two SCell carrier frequencies,
53 reporting criteria in total if the UE is configured with three SCell carrier frequencies,
62 reporting criteria in total if the UE is configured with four SCell carrier frequencies,
71 reporting criteria in total if the UE is configured with five SCell carrier frequencies,
80 reporting criteria in total if the UE is configured with six SCell carrier frequencies,
35 reporting criteria in total if the UE is configured with one PSCell carrier frequency, and
44 reporting criteria in total if the UE is configured with one PSCell carrier frequency and one SCell carrier frequency.
   Editor's note: the total reporting criteria above are to be updated if all UEs will have to support RS-SINR measurements; the total reporting criteria are to be verified when the UE capabilities related to frame structure 3 are decided.

A UE supporting increased number of carriers to monitor beyond 3 carriers shall be able to support up to 20 reporting criteria for inter-frequency measurement category according to table 8.2.2-1. Additionally such UE shall be able to support in parallel per category up to E_{cat} reporting criteria according to table 8.2.2-1. For the measurement categories belonging to measurements on: S-UTRA intra-frequency cells, E-UTRA inter-frequency cells, and inter-RAT per supported RAT, the UE need not support more than the total number of reporting criteria as follows:
39 reporting criteria in total if the UE is not configured with any SCell carrier frequency,
48 reporting criteria in total if the UE is configured with one SCell carrier frequency,
57 reporting criteria in total if the UE is configured with two SCell carrier frequencies,
48 reporting criteria in total if the UE is configured with one PSCell carrier frequency,
57 reporting criteria in total if the UE is configured with one PSCell carrier frequency and one SCell carrier frequencies,
66 reporting criteria in total if the UE is configured with three SCell carrier frequencies, and
75 reporting criteria in total if the UE is configured with four SCell carrier frequencies.
84 reporting criteria in total if the UE is configured with five SCell carrier frequencies
93 reporting criteria in total if the UE is configured with six SCell carrier frequencies
   Editor's note: the total reporting criteria above are to be updated if all UEs will have to support RS-SINR measurements; the total reporting criteria are to be verified when the UE capabilities related to frame structure 3 are decided.

The UE capable of supporting EN-DC operation with NR PSCell and one or more NR carrier frequencies in total shall be able to support in parallel per category up to E_{cat} reporting criteria according to table 8.2.2-1. For the measurement categories belonging to measurements on: S-UTRA intra-frequency cells, E-UTRA inter-frequency cells, inter-RAT per supported RAT, and NR cells on serving and non-serving carrier frequencies (i.e. without counting other categories that the UE shall always support in parallel), the UE need not support more than the number of reporting criteria, excluding reporting criteria specified in TS 38.133 [50] that are applicable for the UE configured with EN-DC operation, as follows:
[36] reporting criteria if the UE is not configured with any SCell or PSCell carrier frequency or NR SCell or NR PSCell,
[36] reporting criteria if the UE is not configured with any SCell or NR SCell but configured with one NR PSCell carrier frequency.

The UE capable of supporting and configured with NE-DC operation with PSCell and NR PCell and one or more NR carrier frequencies in total shall be able to support in parallel per category up to E_{cat} reporting criteria according to table 8.2.2-1. For the measurement categories belonging to measurements on: E-UTRA intra-frequency cells and E-UTRA inter-frequency cells, inter-RAT per supported RAT, and NR cells on serving and non-serving carrier frequencies (i.e. without counting other categories that the UE shall always support in parallel), the UE need not support more than the number of reporting criteria, excluding reporting criteria specified in TS 38.133 [50] that are applicable for the UE configured with NE-DC operation, as follows:
[TBD] reporting criteria if the UE is not configured with any SCell or NR SCell. Editor's note: the above list is to be updated for the agreed CA combinations with NR PSCell.

TABLE 8.2.2-1
Requirements for reporting criteria per measurement category

| Measurement category | E_{cat} | Note |
|---|---|---|
| Intra-frequency^{Note 1, 5, 6} | 10 | Events for any one or a combination of |
| | | intra-frequency RSRP, RSRQ, and RS- |
| | | SINR^{Note4} for E-UTRA intra-frequency |
| | | cells |
| Intra-frequency UE Rx-Tx time difference^{Note 5} | 2 | Intra-frequency UE Rx-Tx time |
| | | difference measurements reported to E- |
| | | UTRAN via RRC and to positioning |
| | | server via LPP. Applies for UE |
| | | supporting both LPP and UE Rx-Tx |
| | | time difference measurement. |
| Intra-frequency RSTD^{Note 2, 5, 6} | 1 | Intra-frequency RSTD measurement |
| | | reporting for UE supporting OTDOA; 1 |
| | | report capable of minimum 16 cell |
| | | measurements for the intra-frequency |
| Intra-frequency RSRP and RSRQ | 1 | Intra-frequency RSRP and RSRQ |
| measurements for E-CID^{Note 5, 6} | | measurements for E-CID reported to E- |
| | | SMLC via LPP [24]. One report capable |
| | | of at least in total 9 intra-frequency |
| | | RSRP and RSRQ measurements. |
| | | Applicable to UE capable of reporting |
| | | RSRP and RSRQ to E-SMLC via LPP. |
| Intra-frequency RSSI and channel | 1 | One report capable of one UE RSSI and |
| occupancy measurements under operation | | channel occupancy measurement s per |
| with frame structure 3 | | serving carrier frequency. Applicable |
| | | for UE capable of performing and |
| | | reporting UE RSSI and channel |
| | | occupancy under operation with frame |
| | | structure 3. |
| Inter-frequency^{Note 5, 6} | 10/28 | Events for any one or a combination of |
| | | inter-frequency RSRP, RSRQ, and RS- |
| | | SINR^{Note4} for E-UTRA inter-frequency |
| | | cells (see note 3) |
| Inter-frequency RSTD^{Note 2, 5, 6} | 1 | Inter-frequency RSTD measurement |
| | | reporting for UE supporting OTDOA; 1 |
| | | report capable of minimum 16 cell |
| | | measurements for at least one inter- |
| | | frequency. Only applicable as specified |
| | | in Section 8.1.2.6. |
| Inter-frequency RSSI and channel | 1 | One report capable of one UE RSSI and |
| occupancy measurements under operation | | channel occupancy measurement s for |
| with frame structure 3 | | an inter-frequency. Applicable for UE |
| | | capable of performing and reporting UE |
| | | RSSI and channel occupancy under |
| | | operation with frame structure 3. |
| Inter-RAT (GSM, cdma2000 1 × RTT and | 5 | Only applicable for UE with this (inter- |
| HRPD)^{Note 5} | | RAT) capability. This requirement (E_{cat} = 5) |
| | | is per supported RAT. |
| Inter-RAT (UTRAN FDD, UTRAN TDD)^{Note 5} | 5 or 11 | Only applicable for UE with this (inter- |
| | | RAT) capability. This requirement (E_{cat} = |
| | | 5 or 11) is per supported RAT. For UE |
| | | which indicate support for Increased UE |
| | | carrier monitoring UTRA E_{cat} = 11. |
| Inter-RAT NR carrier frequency^{Note 5} | 10 | Events for NR cells on all inter-RAT |
| | | NR carrier frequencies for UE capable |
| | | of EN-DC operation. Only applicable |
| | | for UE with this capability and |
| | | measurements on any of the NR carrier |
| | | frequencies other than the carrier |
| | | frequency of the NR PSCell or NR |
| | | SCell. |
| MBSFN measurements for MDT | 1 | MBSFN measurement reporting for UE |
| | | supporting MBSFN measurements |
| | | (MBSFN RSRP, MBSFN RSRQ, and |
| | | MCH BLER) for MDT [2]; 1 report |
| | | capable of minimum 1 MBSFN RSRP |
| | | measurement [4], 1 MBSFN RSRQ |
| | | measurement [4], and 1 MCH BLER |
| | | measurement [4]. |

Note 1:
When the UE is configured with SCell, PSCell, PCell or NR PSCell carrier frequency, E_{cat} for Intra-frequency is applied per serving frequency.
Note 2:
When the UE is configured with one SCell carrier frequency, the UE shall be capable of supporting at least 2 reporting criteria for all RSTD measurements configured to be performed on PCell carrier frequency, SCell carrier frequency and inter-frequency carrier. When the UE is configured with two SCell carrier frequencies, the UE shall be capable of supporting at least 3 reporting criteria for all RSTD measurements configured to be performed on PCell carrier frequency, the two SCell carrier frequencies and inter- frequency carrier. These requirements apply when there is a single on-going LPP OTDOA location session.
Note 3:
Support of Ecat of 28 for Measurement category Inter-frequency is applied for a UE supporting increased number of carriers to monitor beyond 3.
Note 4:
For UEs supporting RS-SINR measurements (Editor's note: the note is to be removed if the RS-SINR measurement support is mandatory).
Note 5:
Applicable for UE configured with EN-DC operation mode.
Note 6:
Applicable for UE configured with NE-DC operation mode.

MN-SN coordination for measurement reporting criteria in MR-DC will now be discussed.

According to the 3GPP TS 38.133 v16.2.0 and 3GPP TS 36.133 v16.2.0, a coordination between the MN and SN is required in order to guarantee that the UE capabilities regarding the maximum number of supported measurement identities are not exceed. This is guaranteed by a signaling in the 3GPP TS 38.331 v16.2.0 within the inter-node signaling in clause 11.2.2:
CG-Config in accordance with some embodiments of the present disclosure:
   This message is used to transfer the SCG radio configuration as generated by the SgNB or SeNB. It can also be used by a CU to request a DU to perform certain actions, e.g., to request the DU to perform a new lower layer configuration.

Direction: Secondary gNB or eNB to master gNB or eNB, alternatively CU to DU.

CG-Config message

-- ASN1START
-- TAG-CG-CONFIG-START

| | |
|---|---|
| CG-Config ::= | SEQUENCE { |
| criticalExtensions | CHOICE { |
| c1 | CHOICE{ |
| cg-Config | CG-Config-IEs, |

spare3 NULL, spare2 NULL, spare1 NULL

| | |
|---|---|
| }, | SEQUENCE { } |
| criticalExtensionsFuture | |
| } | |
| } | |

CG-Config-Ies ::= SEQUENCE {

| | |
|---|---|
| scg-CellGroupConfig | OCTET STRING |

(CONTAINING RRCReconfiguration) OPTIONAL,

| | |
|---|---|
| scg-RB-Config | OCTET STRING |

(CONTAINING RadioBearerConfig) OPTIONAL,

| | |
|---|---|
| configRestrictModReq | ConfigRestrictModReqSCG |
| OPTIONAL, | |
| drx-InfoSCG | DRX-Info |
| OPTIONAL, | |
| candidateCellInfoListSN | OCTET STRING |

(CONTAINING MeasResultList2NR) OPTIONAL,

| | |
|---|---|
| measConfigSN | MeasConfigSN |
| OPTIONAL, | |
| selectedBandCombination | BandCombinationInfoSN |
| OPTIONAL, | |
| fr-InfoListSCG | FR-InfoList |
| OPTIONAL, | |
| candidateServingFreqListNR | CandidateServingFreqListNR |
| OPTIONAL, | |
| nonCriticalExtension | CG-Config-v1540-Ies |
| OPTIONAL | |
| } | |
| CG-Config-v1540-Ies ::= | SEQUENCE { |
| pSCellFrequency | ARFCN-ValueNR |
| OPTIONAL, | |
| reportCGI-RequestNR | SEQUENCE { |
| requestedCellInfo | SEQUENCE { |
| ssbFrequency | ARFCN-ValueNR, |
| cellForWhichToReportCGI | PhysCellId |
| } | |
| OPTIONAL | |

}
OPTIONAL,

| | |
|---|---|
| ph-InfoSCG | PH-TypeListSCG |
| OPTIONAL, | |
| nonCriticalExtension | CG-Config-v1560-Ies |
| OPTIONAL | |
| } | |
| CG-Config-v1560-Ies ::= | SEQUENCE { |
| pSCellFrequencyEUTRA | ARFCN-ValueEUTRA |
| OPTIONAL, | |
| scg-CellGroupConfigEUTRA | OCTET STRING |
| OPTIONAL, | |
| candidateCellInfoListSN-EUTRA | OCTET STRING |
| OPTIONAL, | |
| candidateServingFreqListEUTRA | |
| CandidateServingFreqListEUTRA | OPTIONAL, |
| needForGaps | ENUMERATED {true} |
| OPTIONAL, | |
| drx-ConfigSCG | DRX-Config |
| OPTIONAL, | |
| reportCGI-RequestEUTRA | SEQUENCE { |
| requestedCellInfoEUTRA | SEQUENCE { |
| eutraFrequency | ARFCN- |
| ValueEUTRA, | |

cellForWhichToReportCGI-EUTRA EUTRA-

| | |
|---|---|
| PhysCellId | |
| } | |
| OPTIONAL | |
| } | |
| OPTIONAL, | |
| nonCriticalExtension | CG-Config-v1590-Ies |
| OPTIONAL | |
| } | |
| CG-Config-v1590-Ies ::= | SEQUENCE { |
| scellFrequenciesSN-NR | SEQUENCE (SIZE (1.. |

maxNrofServingCells-1)) OF ARFCN-ValueNR OPTIONAL,

| | |
|---|---|
| scellFrequenciesSN-EUTRA | SEQUENCE (SIZE (1.. |

maxNrofServingCells-1)) OF ARFCN-ValueEUTRA OPTIONAL,

| | |
|---|---|
| nonCriticalExtension | CG-Config-v16xx-Ies |
| OPTIONAL | |
| } | |
| CG-Config-v16xx-Ies ::= | SEQUENCE { |
| drx-InfoSCG2 | DRX-Info2 |
| OPTIONAL, | |
| nonCriticalExtension | SEQUENCE { } |
| OPTIONAL | |
| } | |
| PH-TypeListSCG ::= | SEQUENCE (SIZE |

(1..maxNrofServingCells)) OF PH-InfoSCG

| | |
|---|---|
| PH-InfoSCG ::= | SEQUENCE { |
| servCellIndex | ServCellIndex, |
| ph-Uplink | PH-UplinkCarrierSCG, |
| ph-SupplementaryUplink | PH-UplinkCarrierSCG |
| OPTIONAL, | |
| ... | |
| } | |
| PH-UplinkCarrierSCG ::= | SEQUENCE{ |
| ph-Type1or3 | ENUMERATED {type1, |
| | type3}, |
| ... | |
| } | |
| MeasConfigSN ::= | SEQUENCE { |
| measuredFrequenciesSN | SEQUENCE (SIZE |

(1..maxMeasFreqsSN)) OF NR-FreqInfo OPTIONAL,

| | |
|---|---|
| ... | |
| } | |
| NR-FreqInfo ::= | SEQUENCE { |
| measuredFrequency | ARFCN-ValueNR |
| OPTIONAL, | |
| ... | |
| } | |
| ConfigRestrictModReqSCG ::= | SEQUENCE { |
| requestedBC-MRDC | BandCombinationInfoSN |

OPTIONAL,

| | |
|---|---|
| requestedP-MaxFR1 | P-Max |

```
OPTIONAL,
  ...,
  [ [
  requestedPDCCH-BlindDetectionSCG  INTEGER (1..15)
OPTIONAL,
```

| | |
|---|---|
| requestedP-MaxEUTRA | P-Max |

```
OPTIONAL
  ] ] ,
  [ [
```

| | |
|---|---|
| requestedP-MaxFR2-r16 | P-Max |

OPTIONAL
] ]

}

BandCombinationIndex ::= INTEGER (1..maxBandComb)

| | |
|---|---|
| BandCombinationInfoSN ::= | SEQUENCE { |
| bandcombinationIndex | BandCombinationIndex, |
| requestedFeatureSets | FeatureSetEntryIndex |
| } | |

FR-InfoList ::= SEQUENCE (SIZE (1..maxNrofServingCells-1)) OF FR-

Info

```
FR-Info ::= SEQUENCE {
  servCellIndex  ServCellIndex,
  fr-Type ENUMERATED {fr1, fr2}
```

}

CandidateServingFreqListNR ::= SEQUENCE (SIZE (1.. maxFreqIDC-
MRDC)) OF ARFCN-ValueNR
CandidateServingFreqListEUTRA : ::= SEQUENCE (SIZE (1..
maxFreqIDC-MRDC)) OF ARFCN-ValueEUTRA

-- TAG-CG-CONFIG-STOP
-- ASN1STOP

CG-Config field descriptions
candidateCellInfoListSN
Contains information regarding cells that the source secondary node suggests the target
secondary gNB to consider configuring.
candidateCellInfoListSN-EUTRA
Includes the MeasResultList3EUTRA as specified in TS 36.331 [10]. Contains information
regarding cells that the source secondary node suggests the target secondary eNB to consider
configuring. This field is only used in NE-DC.
candidateServingFreqListNR, candidateServingFreqListEUTRA
Indicates frequencies of candidate serving cells for In-Device Co-existence Indication (see TS
36.331 [10]).
configRestrictModReq
Used by SN to request changes to SCG configuration restrictions previously set by MN to ensure
UE capabilities are respected. E.g. can be used to request configuring an NR band combination
whose use MN has previously forbidden.
Drx-ConfigSCG
This field contains the complete DRX configuration of the SCG. This field is only used in NR-
DC.
Drx-InfoSCG
This field contains the DRX long and short cycle configuration of the SCG. This field is used in
(NG)EN-DC and NE-DC.
Drx-InfoSCG2
This field contains the drx-onDurationTimer configuration of the SCG. This field is only used in
(NG)EN-DC.
Fr-InfoListSCG
Contains information of FR information of serving cells that include Pscell and Scells configured
in SCG.
measuredFrequenciesSN
Used by SN to indicate a list of frequencies measured by the UE.
needForGaps
In NE-DC, indicates wheter the SN requests gNB to configure measurements gaps.
Ph-InfoSCG
Power headroom information in SCG that is needed in the reception of PHR MAC CE of MCG
ph-SupplementaryUplink
Power headroom information for supplementary uplink. In the case of (NG)EN-DC and NR-DC,
this field is only present when two UL carriers are 21ignalling for a serving cell and one UL
carrier reports type1 PH while the other reports type 3 PH.
Ph-Typelor3
Type of power headroom for a certain serving cell in SCG (PSCell and activated Scells). Value
type1 refers to type 1 power headroom, value type3 refers to type 3 power headroom. (See TS
38.321 [3]).
Ph-Uplink
Power headroom information for uplink.
pSCellFrequency, pSCellFrequencyEUTRA
Indicates the frequency of PSCell in NR (i.e., pSCellFrequency) or E-UTRA (i.e.,
pSCellFrequencyEUTRA). In this version of the specification, pSCellFrequency is not used in
NE-DC whereas pSCellFrequencyEUTRA is only used in NE-DC.
reportCGI-RequestNR, reportCGI-RequestEUTRA
Used by SN to indicate to MN about configuring reportCGI procedure. The request may
optionally contain information about the cell for which SN intends to configure reportCGI
procedure. In this version of the specification, the reportCGI-RequestNR is used in (NG)EN-DC
and NR-DC whereas reportCGI-RequestEUTRA is used only for NE-DC.
requestedBC-MRDC
Used to request configuring a band combination and corresponding feature sets which are
forbidden to use by MN (i.e. outside of the allowedBC-ListMRDC) to allow re-negotiation of the
UE capabilities for SCG configuration.
requestedPDCCH-BlindDetectionSCG
Requested value of the reference number of cells for PDCCH blind detection allowed to be
configured for the SCG.
22ignallin-MaxEUTRA
Requested value for the maximum power for the serving cells the UE can use in E-UTRA SCG.
This field is only used in NE-DC.
22ignallin-MaxFR1
Requested value for the maximum power for the serving cells on frequency range 1 (FR1) in this
secondary cell group (see TS 38.104 [12]) the UE can use in NR SCG.
22ignallin-MaxFR2
Requested value for the maximum power for the serving cells on frequency range 2 (FR2) in this
secondary cell group the UE can use in NR SCG. This field is only used in NR-DC.
scellFrequenciesSN-EUTRA, scellFrequenciesSN-NR
Indicates the frequency of all Scells configured in SCG. The field scellFrequenciesSN-EUTRA is
used in NE-DC; the field scellFrequenciesSN-NR is used in (NG)EN-DC and NR-DC. In
(NG)EN-DC, the field is optionally provided to the MN.
Scg-CellGroupConfig
Contains the RRCReconfiguration message (containing only secondaryCellGroup and/or
measConfig):
to be sent to the UE, used upon SCG establishment or modification, as generated (entirely)
by the (target) SgNB. In this case, the SN sets the RRCReconfiguration message in
accordance with clause 6 e.g. regarding the “Need” or “Cond” statements.
Or
including the current SCG configuration of the UE, when provided in response to a query
from MN, or in SN triggered SN change in order to enable delta 22ignalling by the target
SN. In this case, the SN sets the RRCReconfiguration message in accordance with clause
11.2.3.
The field is absent if neither SCG (re)configuration nor SCG configuration query nor SN
triggered SN change is performed, e.g. at inter-node capability/configuration coordination which
does not result in SCG (re)configuration towards the UE. This field is not applicable in NE-DC.
Scg-CellGroupConfigEUTRA
Includes the E-UTRA RRCConnectionReconfiguration message as specified in TS 36.331 [10].
In this version of the specification, the E-UTRA RRC message can only include the field scg-
Configuration. Used to (re-)configure the SCG configuration upon SCG establishment or
modification, as generated (entirely) by the (target) SeNB. This field is only used in NE-DC.
Scg-RB-Config
Contains the IE RadioBearerConfig:
to be sent to the UE, used to (re-)configure the SCG RB configuration upon SCG
establishment or modification, as generated (entirely) by the (target) SgNB or SeNB. In this
case, the SN sets the RadioBearerConfig in accordance with clause 6, e.g. regarding the
“Need” or “Cond” statements.
Or
including the current SCG RB configuration of the UE, when provided in response to a
query from MN or in SN triggered SN change or bearer type change between SN
terminated bearer to MN terminated bearer in order to enable delta 23ignalling by the MN
or target SN. In this case, the SN sets the RadioBearerConfig in accordance with clause
11.2.3.
The field is absent if neither SCG (re)configuration nor SCG configuration query nor SN
triggered SN change is performed, e.g. at inter-node capability/configuration coordination which
does not result in SCG RB (re)configuration.
selectedBandCombination
Indicates the band combination selected by SN in (NG)EN-DC, NE-DC, and NR-DC. The SN
should inform the MN with this field whenever the band combination and/or feature set it
selected for the SCG changes (i.e. even if the new selection concerns a band combination and/or
feature set that is allowed by the allowedBC-ListMRDC)
BandCombinationInfoSN field descriptions
bandCombinationIndex
In case of (NG)EN-DC and NR-DC, this field indicates the position of a band combination in the
supportedBandCombinationList. In case of NE-DC, this field indicates the position of a band
combination in the supportedBandCombinationList and/or
supportedBandCombinationListNEDC-Only. Band combination entries in
supportedBandCombinationList are referred by an index which corresponds to the position of a
band combination in the supportedBandCombinationList. Band combination entries in
supportedBandCombinationListNEDC-Only are referred by an index which corresponds to the
position of a band combination in the supportedBandCombinationListNEDC-Only increased by
the number of entries in supportedBandCombinationList.
requestedFeatureSets
The position in the FeatureSetCombination which identifies one FeatureSetUplink/Downlink for
each band entry in the associated band combination

CG-ConfigInfo in accordance with some embodiments of the present disclosure:
   This message is used by master eNB or gNB to request the SgNB or SeNB to perform certain actions e.g. to establish, modify or release an SCG. The message may include additional information e.g. to assist the SgNB or SeNB to set the SCG configuration. It can also be used by a CU to request a DU to perform certain actions, e.g. to establish, or modify an MCG or SCG.

Direction: Master eNB or gNB to secondary gNB or eNB, alternatively CU to DU.

CG-ConfigInfo message

-- ASN1START
-- TAG-CG-CONFIG-INFO-START

| | |
|---|---|
| CG-ConfigInfo ::= | SEQUENCE { |
| criticalExtensions | CHOICE { |
| c1 | CHOICE{ |
| cg-ConfigInfo | CG-ConfigInfo-IEs, |

spare3 NULL, spare2 NULL, spare1 NULL

| | |
|---|---|
| }, | |
| criticalExtensionsFuture | SEQUENCE { } |
| } | |
| } | |
| CG-ConfigInfo-IEs ::= | SEQUENCE { |
| ue-CapabilityInfo | OCTET STRING (CONTAINING UE- |
| CapabilityRAT-ContainerList) | OPTIONAL, -- Cond SN-AddMod |
| candidateCellInfoListMN | MeasResultList2NR |
| OPTIONAL, | |
| candidateCellInfoListSN | OCTET STRING (CONTAINING |
| MeasResultList2NR) | OPTIONAL, |
| measResultCellListSFTD-NR | MeasResultCellListSFTD-NR |
| OPTIONAL, | |
| scgFailureInfo | SEQUENCE { |
| failureType | ENUMERATED { t310-Expiry, |
| randomAccessProblem, | |
| | rlc- |

MaxNumRetx, synchReconfigFailure-SCG,

| | |
|---|---|
| | scg- |
| reconfigFailure, | |
| | srb3- |
| IntegrityFailure}, | |
| measResultSCG | OCTET STRING (CONTAINING |
| MeasResultSCG-Failure) | |
| } | |

OPTIONAL,

| | |
|---|---|
| configRestrictInfo | ConfigRestrictInfoSCG |
| OPTIONAL, | |
| drx-InfoMCG | DRX-Info |
| OPTIONAL, | |
| measConfigMN | MeasConfigMN |
| OPTIONAL, | |
| sourceConfigSCG | OCTET STRING (CONTAINING |
| RRCReconfiguration) | OPTIONAL, |
| scg-RB-Config | OCTET STRING (CONTAINING |
| RadioBearerConfig) | OPTIONAL, |
| mcg-RB-Config | OCTET STRING (CONTAINING |
| RadioBearerConfig) | OPTIONAL, |
| mrdc-AssistanceInfo | MRDC-AssistanceInfo |
| OPTIONAL, | |
| nonCriticalExtension | CG-ConfigInfo-v1540-IEs |
| OPTIONAL | |
| } | |
| CG-ConfigInfo-v1540-IEs ::= | SEQUENCE { |
| ph-InfoMCG | PH-TypeListMCG |
| OPTIONAL, | |
| measResultReportCGI | SEQUENCE { |
| ssbFrequency | ARFCN-ValueNR, |
| cellForWhichToReportCGI | PhysCellId, |
| cgi-Info | CGI-InfoNR |
| } | |
| OPTIONAL, | |
| nonCriticalExtension | CG-ConfigInfo-v1560-IEs |
| OPTIONAL | |
| } | |

CG-ConfigInfo-v1560-IEs ::= SEQUENCE {

| | |
|---|---|
| candidateCellInfoListMN-EUTRA | OCTET STRING |
| OPTIONAL, | |
| candidateCellInfoListSN-EUTRA | OCTET STRING |
| OPTIONAL, | |
| sourceConfigSCG-EUTRA | OCTET STRING |
| OPTIONAL, | |
| scgFailureInfoEUTRA | SEQUENCE { |
| failureTypeEUTRA | ENUMERATED { t313- |
| Expiry, randomAccessProblem, | |
| | rlc- |
| MaxNumRetx, scg-ChangeFailure}, | |
| measResultSCG-EUTRA | OCTET STRING |
| } | |
| OPTIONAL, | |
| drx-ConfigMCG | DRX-Config |
| OPTIONAL, | |
| measResultReportCGI-EUTRA | SEQUENCE { |
| eutraFrequency | ARFCN-ValueEUTRA, |
| cellForWhichToReportCGI-EUTRA | EUTRA-PhysCellId, |
| cgi-InfoEUTRA | CGI-InfoEUTRA |
| } | |
| OPTIONAL, | |
| measResultCellListSFTD-EUTRA | MeasResultCellListSFTD- |
| EUTRA | OPTIONAL, |
| fr-infoListMCG | FR-InfoList |
| OPTIONAL, | |
| nonCriticalExtension | CG-ConfigInfo-v1570-IEs |
| OPTIONAL | |
| } | |

CG-ConfigInfo-v1570-IEs ::= SEQUENCE {

| | |
|---|---|
| sftdFrequencyList-NR | SFTD-FrequencyList-NR |
| OPTIONAL, | |
| sftdFrequencyList-EUTRA | SFTD-FrequencyList-EUTRA |
| OPTIONAL, | |
| nonCriticalExtension | CG-ConfigInfo-v1590-IEs |

OPTIONAL
}
CG-ConfigInfo-v1590-IEs ::= SEQUENCE {

| | |
|---|---|
| servFrequenciesMN-NR | SEQUENCE (SIZE (1.. |

maxNrofServingCells-1)) OF ARFCN-ValueNR OPTIONAL,

| | |
|---|---|
| nonCriticalExtension | CG-ConfigInfo-v16xy-IEs |

OPTIONAL
}
CG-ConfigInfo-v16xy-IEs ::= SEQUENCE {

| | |
|---|---|
| drx-InfoMCG2 | DRX-Info2 |
| OPTIONAL, | |
| alignedDRX-Indication | ENUMERATED {true} |
| OPTIONAL, | |
| nonCriticalExtension | SEQUENCE { } |
| OPTIONAL | |
| } | |
| SFTD-FrequencyList-NR ::= | SEQUENCE (SIZE |
| (1..maxCellSFTD)) OF ARFCN-ValueNR | |
| SFTD-FrequencyList-EUTRA ::= | SEQUENCE (SIZE |

(1..maxCellSFTD)) OF ARFCN-ValueEUTRA

| | |
|---|---|
| ConfigRestrictInfoSCG ::= | SEQUENCE { |
| allowedBC-ListMRDC | BandCombinationInfoList |
| OPTIONAL, | |
| powerCoordination-FR1 | SEQUENCE { |
| p-maxNR-FR1 | P-Max |
| OPTIONAL, | |
| p-maxEUTRA | P-Max |
| OPTIONAL, | |
| p-maxUE-FR1 | P-Max |

OPTIONAL
}
OPTIONAL,

| | |
|---|---|
| servCellIndexRangeSCG | SEQUENCE { |
| lowBound | ServCellIndex, |
| upBound | ServCellIndex |

}
OPTIONAL, -- Cond SN-AddMod

| | |
|---|---|
| maxMeasFreqsSCG | INTEGER(1..maxMeasFreqsMN) |

```
OPTIONAL,
  dummy
INTEGER(1..maxMeasIdentitiesMN)
OPTIONAL,
  ...,
  [ [
```

| | |
|---|---|
| selectedBandEntriesMNList | SEQUENCE (SIZE |

```
(1..maxBandComb) ) OF SelectedBandEntriesMN OPTIONAL,
  pdcch-BlindDetectionSCG  INTEGER (1..15)
OPTIONAL,
  maxNumberROHC-ContextSessionsSN  INTEGER(0.. 16384)
OPTIONAL
  ] ] ,
  [ [
  maxIntraFreqMeasIdentitiesSCGINTEGER (1..maxMeasIdentitiesMN)
OPTIONAL,
  maxInterFreqMeasIdentitiesSCGINTEGER(1..maxMeasIdentitiesMN)
OPTIONAL
  ] ] ,
  [ [
```

| | |
|---|---|
| p-maxNR-FR1-MCG-r16 | P-Max |
| OPTIONAL, | |
| powerCoordination-FR2-r16 | SEQUENCE { |
| p-maxNR-FR2-MCG-r16 | P-Max |
| OPTIONAL, | |
| p-maxNR-FR2-SCG-r16 | P-Max |
| OPTIONAL, | |
| p-maxUE-FR2-r16 | P-Max |

```
OPTIONAL
  }
OPTIONAL,
  nrdc-PC-mode-FR1-r16 ENUMERATED {semi-static-model, semi-
static-mode2, dynamic} OPTIONAL,
  nrdc-PC-mode-FR2-r16 ENUMERATED {semi-static-model, semi-
static-mode2, dynamic} OPTIONAL,
  maxMeasSRS-ResourceSCG-r16 INTEGER(0..maxNrofSRS-
Resources-r16)  OPTIONAL,
  maxMeasCLI-ResourceSCG-r16 INTEGER(0..maxNrofCLI-RSSI-
Resources-r16)   OPTIONAL
  ] ]
}
SelectedBandEntriesMN ::= SEQUENCE (SIZE
(1..maxSimultaneousBands) ) OF BandEntryIndex
```

| | |
|---|---|
| BandEntryIndex ::= | INTEGER (0.. maxNrofServingCells) |
| PH-TypeListMCG ::= | SEQUENCE (SIZE |

(1..maxNrofServingCells)) OF PH-InfoMCG

| | |
|---|---|
| PH-InfoMCG ::= | SEQUENCE { |
| servCellIndex | ServCellIndex, |
| ph-Uplink | PH-UplinkCarrierMCG, |
| ph-SupplementaryUplink | PH-UplinkCarrierMCG |

OPTIONAL,
...
}

| | |
|---|---|
| PH-UplinkCarrierMCG :: = | SEQUENCE{ |
| ph-Type1or3 | ENUMERATED {type1, type3}, |
| ... | |
| } | |
| BandCombinationInfoList :: = | SEQUENCE (SIZE (1..maxBandComb) ) |

OF BandCombinationInfo

| | |
|---|---|
| BandCombinationInfo ::= | SEQUENCE { |
| bandCombinationIndex | BandCombinationIndex, |
| allowedFeatureSetsList | SEQUENCE (SIZE |

(1..maxFeatureSetsPerBand)) OF FeatureSetEntryIndex
}

| | |
|---|---|
| FeatureSetEntryIndex ::= | INTEGER (1.. |
| maxFeatureSetsPerBand) | |
| DRX-Info ::= | SEQUENCE { |
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER (0..2047), |
| ms2560 | INTEGER(0..2559), |
| ms5120 | INTEGER(0..5119), |
| ms10240 | INTEGER(0..10239) |
| }, | |
| shortDRX | SEQUENCE { |
| drx-ShortCycle | ENUMERATED { |
| | ms2, ms3, ms4, |

ms5, ms6, ms7, ms8, ms10, ms14, ms16, ms20, ms30, ms32,

ms35, ms40, ms64,

ms80, ms128, ms160, ms256, ms320, ms512, ms640, spare9,

spare8, spare7,

spare6, spare5, spare4, spare3, spare2, spare1 },

| | |
|---|---|
| drx-ShortCycleTimer | INTEGER (1..16) |

```
  }
OPTIONAL
}
DRX-Info2 ::=  SEQUENCE {
  drx-onDurationTimer  CHOICE {
```

subMilliSeconds INTEGER (1..31),
milliseconds ENUMERATED {
ms1, ms2, ms3, ms4, ms5, ms6,

ms8, ms10, ms20, ms30, ms40, ms50, ms60,

ms80, ms100, ms200, ms300,

ms400, ms500, ms600, ms800, ms1000, ms1200,

ms1600, spare8, spare7, spare6,

spare5, spare4, spare3, spare2, spare1 }
}
}
MeasConfigMN ::= SEQUENCE {

| | |
|---|---|
| measuredFrequenciesMN | SEQUENCE (SIZE |

(1..maxMeasFreqsMN)) OF NR-FreqInfo OPTIONAL,

| | |
|---|---|
| measGapConfig | SetupRelease { GapConfig } |

OPTIONAL,

| | |
|---|---|
| gapPurpose | ENUMERATED {perUE, perFR1} |

OPTIONAL,

| | |
|---|---|
| ..., | |
| [ [ measGapConfigFR2 | SetupRelease { GapConfig } |
| OPTIONAL | |
| ] ] | |

```
}
MRDC-AssistanceInfo ::= SEQUENCE {
  affectedCarrierFreqCombInfoListMRDC SEQUENCE (SIZE
(1..maxNrofCombIDC)) OF AffectedCarrierFreqCombInfoMRDC,
  ...
```

}

AffectedCarrierFreqCombInfoMRDC ::= SEQUENCE {

| | |
|---|---|
| victimSystemType | VictimSystemType, |
| interferenceDirectionMRDC | ENUMERATED {eutra-nr, nr, |

other, utra-nr-other, nr-other, spare3, spare2, spare1},

| | |
|---|---|
| affectedCarrierFreqCombMRDC | SEQUENCE { |

affectedCarrierFreqCombEUTRA

| | |
|---|---|
| AffectedCarrierFreqCombEUTRA | OPTIONAL, |

```
    affectedCarrierFreqCombNR
AffectedCarrierFreqCombNR
  } OPTIONAL
}
VictimSystemType ::= SEQUENCE {
```

| | |
|---|---|
| gps | ENUMERATED {true} |
| OPTIONAL, | |
| glonass | ENUMERATED {true} |
| OPTIONAL, | |
| bds | ENUMERATED {true} |
| OPTIONAL, | |
| galileo | ENUMERATED {true} |
| OPTIONAL, | |
| wlan | ENUMERATED {true} |
| OPTIONAL, | |
| bluetooth | ENUMERATED {true} |
| OPTIONAL | |
| } | |

AffectedCarrierFreqCombEUTRA ::= SEQUENCE (SIZE
(1..maxNrofServingCellsEUTRA) ) OF ARFCN-ValueEUTRA
AffectedCarrierFreqCombNR ::= SEQUENCE (SIZE
(1..maxNrof ServingCells) ) OF ARFCN-ValueNR
-- TAG-CG-CONFIG-INFO-STOP
-- ASN1STOP

CG-ConfigInfo field descriptions
alignedDRX-Indication
This field is signalled upon MN triggered CGI reporting by the UE that requires aligned DRX
configurations between the MCG and the SCG (i.e. same DRX cycle and on-duration configured
by MN completely contains on-duration configured by SN).
allowedBC-ListMRDC
A list of indices referring to band combinations in MR-DC capabilities from which SN is allowed
to select the SCG band combination. Each entry refers to:
a band combination numbered according to supportedBandCombinationList in the UE-MRDC-
Capability (in case of (NG)EN-DC), or according to supportedBandCombinationList and
supportedBandCombinationListNEDC-Only in the UE-MRDC-Capability (in case of NE-DC), or
according to supportedBandCombinationList in the UE-NR-Capability (in case of NR-DC),
and the Feature Sets allowed for each band entry. All MR-DC band combinations indicated by
this field comprise the MCG band combination, which is a superset of the MCG band(s) selected
by MN.
candidateCellInfoListMN, candidateCellInfoListSN
Contains information regarding cells that the master node or the source node suggests the target
gNB or DU to consider configuring.
For (NG)EN-DC, including CSI-RS measurement results in candidateCellInfoListMN is not
supported in this version of the specification. For NR-DC, including SSB and/or CSI-RS
measurement results in candidateCellInfoListMN is supported.
candidateCellInfoListMN-EUTRA, candidateCellInfoListSN-EUTRA
Includes the MeasResultList3EUTRA as specified in TS 36.331 [10]. Contains information
regarding cells that the master node or the source node suggests the target secondary eNB to
consider configuring. These fields are only used in NE-DC.
configRestrictInfo
Includes fields for which SgNB is explictly indicated to observe a configuration restriction.
drx-ConfigMCG
This field contains the complete DRX configuration of the MCG. This field is only used in NR-
DC.
drx-InfoMCG
This field contains the DRX long and short cycle configuration of the MCG. This field is used in
(NG)EN-DC and NE-DC.
drx-InfoMCG2
This field contains the drx-onDurationTimer configuration of the MCG and a DRX alignment
indication. This field is only used in (NG)EN-DC.
fr-InfoListMCG
Contains information of FR information of serving cells that include PCell and SCell(s)
configured in MCG.
dummy
This field is not used in the specification and SN ignores the received value.
maxInterFreqMeasIdentitiesSCG
Indicates the maximum number of allowed measurement identities that the SCG is allowed to
configure for inter-frequency measurement. The maximum value for this field is 10. If the field is
absent, the SCG is allowed to configure inter-frequency measurements up to the maximum value.
This field is only used in NR-DC.
maxIntraFreqMeasIdentitiesSCG
Indicates the maximum number of allowed measurement identities that the SCG is allowed to
configure for intra-frequency measurement on each serving frequency. The maximum value for
this field is 9 (in case of (NG)EN-DC or NR-DC) or 10 (in case of NE-DC). If the field is absent,
the SCG is allowed to configure intra-frequency measurements up to the maximum value on each
serving frequency.
maxMeasCLI-ResourceSCG
Indicates the maximum number of CLI RSSI resources that the SCG is allowed to configure.
maxMeasFreqsSCG
Indicates the maximum number of NR inter-frequency carriers the SN is allowed to configure
with PSCell for measurements.
maxMeasSRS-ResourceSCG
Indicates the maximum number of SRS resources that the SCG is allowed to configure for CLI
measurement.
maxNumberROHC-ContextSessionsSN
Indicates the maximum number of context sessions allowed to SN terminated bearer, excluding
context sessions that leave all headers uncompressed.
measuredFrequenciesMN
Used by MN to indicate a list of frequencies measured by the UE.
measGapConfig
Indicates the FR1 and perUE measurement gap configuration configured by MN.
measGapConfigFR2
Indicates the FR2 measurement gap configuration configured by MN.
mcg-RB-Config
Contains all of the fields in the IE RadioBearerConfig used in MCG, used by the SN to support
delta configuration to UE, for bearer type change between MN terminated bearer with NR PDCP
to SN terminated bearer. It is also used to indicate the PDCP duplication related information for
MN terminated split bearer (whether duplication is configured and if so, whether it is initially
activated) in SN Addition/Modification procedure. Otherwise, this field is absent.
measResultReportCGI, measResultReportCGI-EUTRA
Used by MN to provide SN with CGI-Info for the cell as per SN's request. In this version of the
specification, the measResultReportCGI is used for (NG)EN-DC and NR-DC and the
measResultReportCGI-EUTRA is used only for NE-DC.
measResultSCG-EUTRA
This field includes the MeasResultSCG-FailureMRDC IE as specified in TS 36.331 [10]. This
field is only used in NE-DC.
measResultSFTD-EUTRA
SFTD measurement results between the PCell and the E-UTRA PScell in NE-DC. This field is
only used in NE-DC.
mrdc-AssistanceInfo
Contains the IDC assistance information for MR-DC reported by the UE (see TS 36.331 [10]).
nrdc-PC-mode-FR1
Indicates the uplink power sharing mode that the UE uses in NR-DC FR1 (see TS 38.213 [13],
clause 7.6).
nrdc-PC-mode-FR2
Indicates the uplink power sharing mode that the UE uses in NR-DC FR2 (see TS 38.213 [13],
clause 7.6).
p-maxEUTRA
Indicates the maximum total transmit power to be used by the UE in the E-UTRA cell group (see
TS 36.104 [33]). This field is used in (NG)EN-DC and NE-DC.
p-maxNR-FR1
Indicates the maximum total transmit power to be used by the UE in the NR cell group across all
serving cells in frequency range 1 (FR1) (see TS 38.104 [12]). The field is used in (NG)EN-DC
and NE-DC.
p-maxUE-FR1
Indicates the maximum total transmit power to be used by the UE across all serving cells in
frequency range 1 (FR1).
p-maxNR-FR1-MCG
Indicates the maximum total transmit power to be used by the UE in the NR cell group across all
serving cells in frequency range 1 (FR1) (see TS 38.104 [12]) the UE can use in NR MCG. This
field is only used in NR-DC.
p-maxNR-FR2-SCG
Indicates the maximum total transmit power to be used by the UE in the NR cell group across all
serving cells in frequency range 2 (FR2) (see TS 38.104 [12]) the UE can use in NR SCG.
p-maxUE-FR2
Indicates the maximum total transmit power to be used by the UE across all serving cells in
frequency range 2 (FR2).
p-maxNR-FR2-MCG
Indicates the maximum total transmit power to be used by the UE in the NR cell group across all
serving cells in frequency range 2 (FR2) (see TS 38.104 [12]) the UE can use in NR MCG.
pdcch-BlindDetectionSCG
Indicates the maximum value of the reference number of cells for PDCCH blind detection
allowed to be configured for the SCG.
ph-InfoMCG
Power headroom information in MCG that is needed in the reception of PHR MAC CE in SCG.
ph-SupplementaryUplink
Power headroom information for supplementary uplink. For UE in (NG)EN-DC, this field is
absent.
ph-Type1or3
Type of power headroom for a serving cell in MCG (PCell and activated SCells). type1 refers to
type 1 power headroom, type3 refers to type 3 power headroom. (See TS 38.321 [3]).
ph-Uplink
Power headroom information for uplink.
powerCoordination-FR1
Indicates the maximum power that the UE can use in FR1.
powerCoordination-FR2
Indicates the maximum power that the UE can use in frequency range 2 (FR2). This field is only
used in NR-DC.
scgFailureInfo
Contains SCG failure type and measurement results. In case the sender has no measurement
results available, the sender may include one empty entry (i.e. without any optional fields
present) in measResultPerMOList. This field is used in (NG)EN-DC and NR-DC.
scgFailureInfoEUTRA
Contains SCG failure type and measurement results of the EUTRA secondary cell group. This
field is only used in NE-DC.
scg-RB-Config
Contains all of the fields in the IE RadioBearerConfig used in SCG, used to allow the target SN
to use delta configuration to the UE, e.g. during SN change. The field is signalled upon change of
SN. Otherwise, the field is absent. This field is also absent when master eNB uses full
configuration option.
selectedBandEntriesMNList
A list of indices referring to the position of a band entry selected by the MN, in each band
combination entry in allowedBC-ListMRDC IE. BandEntryIndex 0 identifies the first band in the
bandList of the BandCombination, BandEntryIndex 1 identifies the second band in the bandList
of the BandCombination, and so on. This selectedBandEntriesMNList includes the same number
of entries, and listed in the same order as in allowedBC-ListMRDC. The SN uses this information
to determine which bands out of the NR band combinations in allowedBC-ListMRDC it can
configure in SCG. This field is only used in NR-DC.
servCellIndexRangeSCG
Range of serving cell indices that SN is allowed to configure for SCG serving cells.
servFrequenciesMN-NR
Indicates the frequency of all serving cells that include PCell and SCell(s) configured in MCG.
This field is only used in NR-DC.
sftdFrequencyList-NR
Includes a list of SSB frequencies. Each entry identifies the SSB frequency of a PSCell, which
corresponds to one MeasResultCellSFTD-NR entry in the MeasResultCellListSFTD-NR.
sftdFrequencyList-EUTRA
Includes a list of E-UTRA frequencies. Each entry identifies the carrier frequency of a PSCell,
which corresponds to one MeasResultSFTD-EUTRA entry in the MeasResultCellListSFTD-
EUTRA.
sourceConfigSCG
Includes all of the current SCG configurations used by the target SN to build delta configuration
to be sent to UE, e.g. during SN change. The field contains the RRCReconfiguration message, i.e.
including secondaryCellGroup and measConfig. The field is signalled upon change of SN, unless
MN uses full configuration option. Otherwise, the field is absent.
sourceConfigSCG-EUTRA
Includes the E-UTRA RRCConnectionReconfiguration message as specified in TS 36.331 [10].
In this version of the specification, the E-UTRA RRC message can only include the field scg-
Configuration. In this version of the specification, this field is absent when master gNB uses full
configuration option. This field is only used in NE-DC.
ue-CapabilityInfo
Contains the IE UE-CapabilityRAT-ContainerList supported by the UE (see NOTE 3). A gNB
that retrieves MRDC related capability containers ensures that the set of included MRDC
containers is consistent w.r.t. the feature set related information.
BandCombinationInfo field descriptions
allowedFeatureSetsList
Defines a subset of the entries in a FeatureSetCombination. Each index identifies a position in
the FeatureSetCombination, which corresponds to one FeatureSetUplink/Downlink for each band
entry in the associated band combination.
bandCombinationIndex
In case of (NG)EN-DC and NR-DC, this field indicates the position of a band combination in the
supportedBandCombinationList. In case of NE-DC, this field indicates the position of a band
combination in the supportedBandCombinationList and/or
supportedBandCombinationListNEDC-Only. Band combination entries in
supportedBandCombinationList are referred by an index which corresponds to the position of a
band combination in the supportedBandCombinationList. Band combination entries in
supportedBandCombinationListNEDC-Only are referred by an index which corresponds to the
position of a band combination in the supportedBandCombinationListNEDC-Only increased by
the number of entries in supportedBandCombinationList.

| Conditional | |
|---|---|
| Presence | Explanation |
| SN-AddMod | The field is mandatory present upon |
| | SN addition and SN change. It is |
| | optionally present upon SN modification |
| | and inter-MN handover without SN |
| | change. Otherwise, the field is absent. |

| Source RAT | NR capabilities | E-UTRA capabilities | MR-DC capabilities |
|---|---|---|---|
| E-UTRA | Included | Not included | Included |

NOTE 3:
The following table indicates per source RAT whether RAT capabilities are included or not in ue-CapabilityInfo.

According to the current signaling in clause 11.2.2 of 3GPP TS 38.331 v16.2.0, the MN can restrict the SN to use a maximum number of measurement identities. However, although the MN can use such signaling in order to communicate the maximum number of allowed measurement identities that the SCG is allowed to configure for inter- and intra-frequency measurements, it is inflexible as it sets a hard cap on the measurements identities to be configured by the SN (and indirectly by the MN, as the MN is then able to configure only the remaining measurements identities available).

According to this, if the MN reaches its limit of measurements identities, it knows how many measurements identities the SN is allowed to configure (e.g., since the MN can use the new fields to signal this restriction). If the MN wants to change such limit on the SN, the MN can configure additional measurement identities, but a problem may be that the MN is not aware of the current number of measurements identities configured by the SN. In this case, the MN may refrain from adding more measurements, even though the UE's limit may not be reached (e.g., in case the SN has configured less measurements identities than the maximum allowed).

A similar problem may occur on the SN side as well, because the SN may not necessarily know how many measurements identities that the MN has configured. Thus, the SN may refrain from adding some new measurements identities when the SN reaches the maximum allowed, even though the MN may have configured only some measurement identities and it was still possible to add more measurement identities without reaching the UE's capability.

Therefore, in the above approach, the maximum number of measurement identities supported by the UE may not be efficiently shared between the MN and SN. As a consequence, such an approach may lead to a degradation of the performance or wrong network behavior under particular circumstances. Further, since the coordination between the MN and SN may not be optimal, such an approach may not guarantee that the UE capabilities are not exceeded. As a consequence, such an approach, also may lead to a RRC reestablishment and to a drop of the connectivity for several seconds.

It is noted that the need for configuring measurements can vary at the MN and SN, depending on the coverage and load aspect in the two nodes (and cells of the two nodes). In some scenarios, for example, when a UE is in a poor coverage area in a MN but in a good coverage of a SN, the SN may not need to configure a lot of measurements, while the MN may need to configure a lot of measurements.

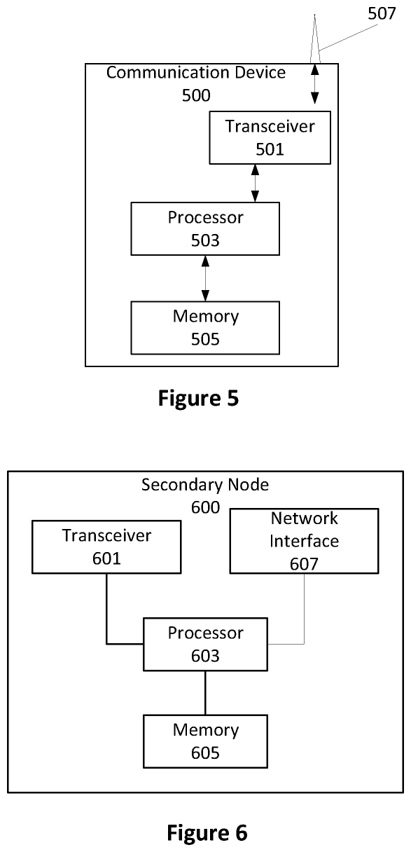

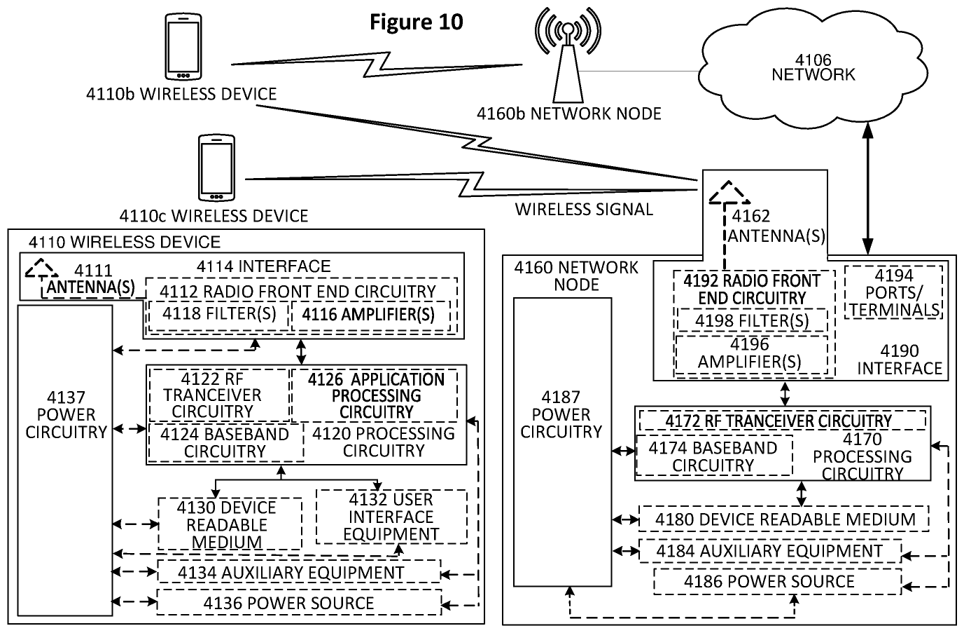

FIG. 5 is a block diagram illustrating elements of a communication device 500 (also referred to as a UE) configured to support measurement identities according to embodiments of the present disclosures. (UE 500 may be provided, for example, as discussed below with respect to wireless device 4110 of FIG. 10.) As shown, the UE 500 may include an antenna 507 (e.g., corresponding to antenna 4111 of FIG. 10), and transceiver circuitry 501 (also referred to as a transceiver, e.g., corresponding to interface 4114 of FIG. 10) including a transmitter and a receiver configured to provide uplink and downlink radio communications with a base station(s) (e.g., corresponding to network node 4160 of FIG. 10, also referred to as a RAN node, a secondary node or a master node) of a radio access network. UE 500 may also include processing circuitry 503 (also referred to as a processor, e.g., corresponding to processing circuitry 4120 of FIG. 10) coupled to the transceiver circuitry, and memory circuitry 505 (also referred to as memory, e.g., corresponding to device readable medium 4130 of FIG. 10) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that separate memory circuitry is not required. UE 500 may also include an interface (such as a user interface) coupled with processing circuitry 503, and/or UE 500 may be incorporated in a vehicle.

As discussed herein, operations of UE 500 may be performed by processing circuitry 503 and/or transceiver circuitry 501. For example, processing circuitry 503 may control transceiver circuitry 501 to transmit communications through transceiver circuitry 501 over a radio interface to a radio access network node (also referred to as a base station) and/or to receive communications through transceiver circuitry 501 from a RAN node over a radio interface. Moreover, modules may be stored in memory circuitry 505, and these modules may provide instructions so that when instructions of a module are executed by processing circuitry 503, processing circuitry 503 performs respective operations (e.g., operations discussed below with respect to Example Embodiments relating to wireless devices). In some embodiments, UE 500 may include a display for displaying images decoded from a received bitstream. For example, UE 500 can include a television.

FIG. 6 is a block diagram illustrating elements of a secondary node 600 configured to coordinate a number of measurement identities exchanged with a master node according to embodiments of the present disclosure. The secondary node 600 may include network interface circuitry 607 (also referred to as a network interface) configured to communicate with other devices. The secondary node 600 may also include processing circuitry 603 (also referred to as a processor) coupled to memory circuitry 605 (also referred to as memory) coupled to the processing circuitry. The memory circuitry 605 may include computer readable program code that when executed by the processing circuitry 603 causes the processing circuitry to perform operations according to embodiments disclosed herein. According to other embodiments, processing circuitry 603 may be defined to include memory so that a separate memory circuitry is not required.

As discussed herein, operations of the secondary node 600 may be performed by processing circuitry 603 and network interface 607. For example, processing circuitry 603 may control network interface 607 to receive and/or transmit signals to a master node. Moreover, modules may be stored in memory 605, and these modules may provide instructions so that when instructions of a module are executed by processing circuitry 603, processing circuitry 603 performs respective operations (e.g., operations discussed below with respect to Example Embodiments relating to secondary nodes).

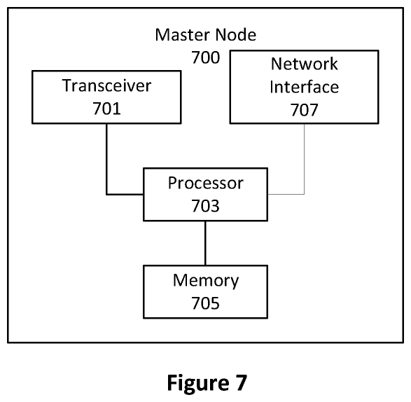

FIG. 7 is a block diagram illustrating elements of a master node 700 configured to coordinate a number of measurement identities exchanged with a secondary node according to embodiments of the present disclosure. The master node 700 may include network interface circuitry 707 (also referred to as a network interface) configured to communicate with other devices. The secondary node 700 may also include processing circuitry 703 (also referred to as a processor) coupled to memory circuitry 705 (also referred to as memory) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required.

As discussed herein, operations of the master node 700 may be performed by processing circuitry 703 and network interface 707. For example, processing circuitry 703 may control network interface 707 to receive and/or transmit signals to a secondary node. Moreover, modules may be stored in memory 705, and these modules may provide instructions so that when instructions of a module are executed by processing circuitry 703, processing circuitry 703 performs respective operations (e.g., operations discussed below with respect to Example Embodiments relating to master nodes).

Various embodiments described herein may allow a SN to request from the MN a new value for a maximum number of measurement identities or to signal (e.g., release) measurement identities that are not used. This may help the MN to configure additional measurement identities, if needed, and to not waste unused measurement identities.

Further, in some embodiments, assuming the SN has already received the maximum number of measurement identities by the MN, the SN behavior is clarified with the new value for the maximum number of measurement identities. For example, incorrect network behavior may be avoided and the UE capabilities may not be exceeded.

Potential advantages that may be provided by various embodiments described herein include that the maximum number of measurement identities supported by the UE may be efficiently shared between the MN and SN. As a consequence, a degradation of the performance or incorrect network behavior under particular circumstances may be avoided. Further, coordination between the MN and SN may become optimal or improved. As a consequence, UE capabilities may not be exceeded and, thus, a RRC reestablishment procedure with a drop of the connectivity for several seconds may be avoided.

Various embodiments disclosed herein can be applied, without limitation, to the MR-DC options discussed herein, to a centralized unit (CU) split configuration, etc. While embodiments discussed herein are explained in the non-limiting context of NR, the invention is not so limited and can be applied without any loss of meaning to dual connectivity scenarios involving two (or more) different radio access networks (RATs). Further, the terms “measurement identities” and “measurement reporting criteria” herein may be used interchangeably.

Various embodiments disclosed herein describe operations performed by a SN if previously configured with a maximum number of measurement identities to be used, the SN signals a request to a MN for a new value for the maximum number of measurement identities the SN needs to configure more measurement identities.

In some embodiments, the request sent by the SN is represented by an exact number of the measurement identities that are needed (e.g., requested_IDs=needed_IDs−configured_IDs).

In some embodiments, the request sent by the SN is represented by a maximum number of measurement identities that the SN wants to configure (e.g., requested_IDs=needed_IDs). In this case, the MN calculates the additional needed measurement identities by considering the measurement identities the MN already signaled to the SN.

In some embodiments, the request sent by the SN is represented by in indication (e.g., 1 bit) to inform the MN that more measurement identities than the number of measurement identities previously configured are needed.

In some embodiments, the SN sets this indication to “0” if the requested number of measurement identities is lower than the number of measurement identities already configured.

In some embodiments, the SN sets this indication to “1” if the requested number of measurement identities is higher than the number of measurement identities already configured.

In another embodiment, assuming that the SN already has a maximum number of measurement identities configured by the MN, upon receiving a new maximum number of measurement identities from the MN, the SN replies to the MN that such new configuration is rejected.

In some embodiments, upon receiving a new maximum number of measurement identities from the MN, the SN replies to the MN with the available/not allocated measurement identities (e.g., in case the maximum number of measurements identities has not been filled by the SN).

In some embodiments, upon receiving a new maximum number of measurement identities from the MN, the SN replies to the MN with the number of the requested measurement identities. In this case, the SN can release the configured measurement identities that are necessary to meet the demand of the MN.

In some embodiments, upon sending the request for new maximum number of measurement identities or after releasing the number of measurement identities requested by the MN, the SN applies the new SCG configuration to meet the UE capabilities after the MN has acknowledged the reception of the new maximum number of measurement identities.

In some embodiments, each time the SN signals/requests a new maximum number of measurement identities to the MN, the SN triggers a SgNB/SeNB modification procedure.

In some embodiments, each time the SN signals/requests a new maximum number of measurement identities to the MN, the SN triggers a DC procedure that involves the change of the SCG configuration.

In some embodiments, the SN sends the request or any other field concerning the maximum number of measurement identities to the MN via an inter-node RRC messages.

In some embodiments, the SN sends the request or any other field concerning the maximum number of measurement identities to the MN via an X2/Xn signaling.

In some embodiments, once the MN reaches its limit regarding the maximum number of measurement identities, the MN sends an indication to the SN with a new number of maximum measurement identities. For example, this indication may indicate that more measurement identities are needed or that less measurement identities are needed.

In some embodiments, upon receiving a request from the SN that new measurement identities are needed, the MN ignores the request if no spare measurement identities are available (e.g., because the MN has filled all the available measurement identities).

In some embodiments, upon receiving a request from the SN that new measurement identities are needed, the MN informs the SN of the spare measurement identities that the SN can use, in addition to the measurement identities configured previously (e.g., this means that the MN will signal to the SN only the measurement identities that have not been used).

In some embodiments, upon receiving a request from the SN that new measurement identities are needed, the MN replies to the SN with the number of the requested measurement identities. In this case, the MN can release the configured measurement identities that are necessary to meet the demand of the SN.

In some embodiments, upon receiving from the SN a request for new measurement identities with an indication set to “0”, the SN replies to the MN with a maximum number of measurement identities that is lower with respect to the number of measurement identities previously configured.

In some embodiments, upon receiving from the SN a request for new measurement identities with an indication set to “1”, the SN replies to the MN with a maximum number of measurement identities that is higher with respect to the number of measurement identities previously configured.

In some embodiments, upon sending the request for new maximum number of measurement identities or after releasing the number of measurement identities requested by the SN, the MN applies the new MCG configuration to meet the UE capabilities after the SN has acknowledged the reception of the new maximum number of measurement identities.

In some embodiments, each time the MN signals/requests a new maximum number of measurement identities to the SN, the MN triggers a SgNB/SeNB modification procedure.

In some embodiments, each time the MN signals/requests a new maximum number of measurement identities to the SN, the MN triggers a DC procedure that involves a change of the SCG configuration.

In some embodiments, the MN sends the request or any other field concerning the maximum number of measurement identities to the SN via an inter-node RRC messages.

In some embodiments, the MN sends the request or any other field concerning the maximum number of measurement identities to the SN via X2/Xn signaling.

Operational advantages that may be provided by one or more embodiments may include that a number of measurement identities supported by a UE (e.g., a maximum number) may be efficiently shared between the MN and SN. As a consequence, a degradation of the performance or a wrong network behavior under particular circumstances may be avoided. Further, since the coordination between the MN and SN may be optimal or improved, the UE capabilities may not be exceeded and, thus, a RRC reestablishment procedure with a drop of the connectivity for several seconds may be avoided.

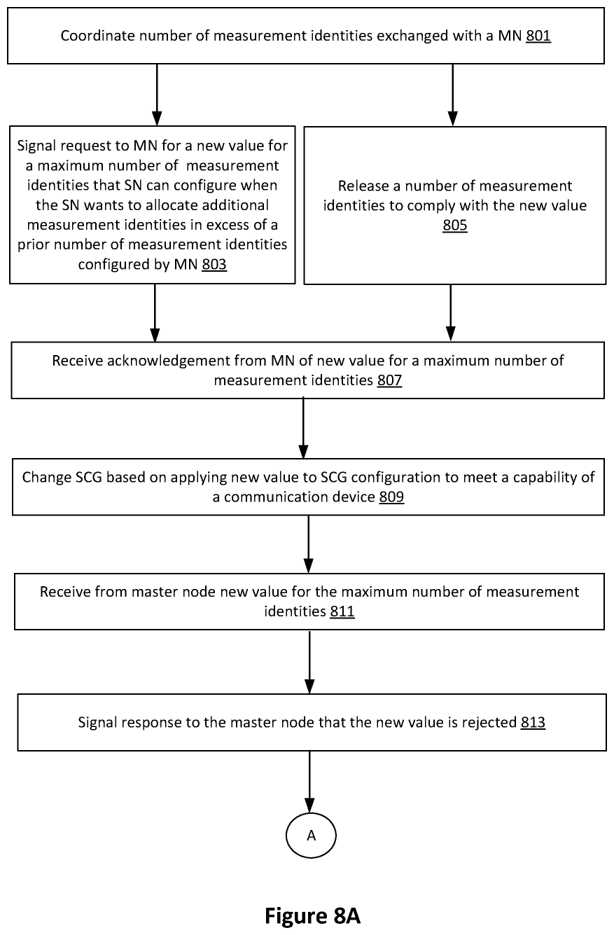

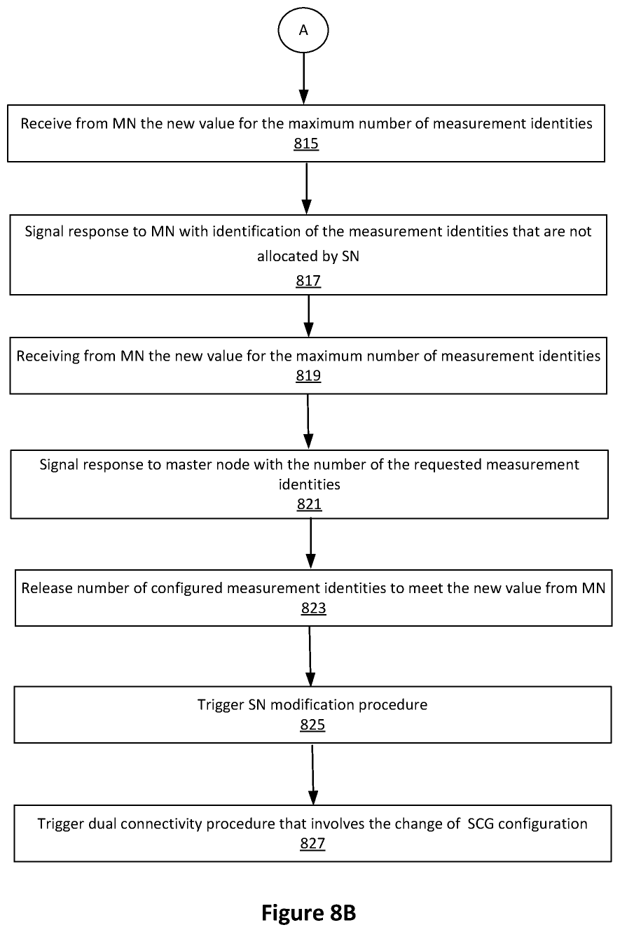

Operations of a secondary node 205a, 205b (implemented using the structure of FIG. 6) will now be discussed with reference to the flow chart of FIGS. 8A-8B according to some embodiments of the present disclosure. For example, modules may be stored in memory 605 of FIG. 6, and these modules may provide instructions so that when the instructions of a module are executed by respective secondary node processing circuitry 603, processing circuitry 603 performs respective operations of the flow charts.

Referring initially to FIG. 8A, at block 801, processing circuitry 603 coordinates a number of measurement identities exchanged with a master node. The coordinating includes at least one of the following: signaling (block 803) a request to the master node for a new value for a maximum number of measurement identities that the secondary node can configure when the secondary node wants to allocate additional measurement identities in excess of a prior number of measurement identities configured by the master node; and subsequent to receiving from the master node the new value for the maximum number of measurement identities and wherein the secondary node previously configured the measurement identities based on a prior value for the maximum number measurement identities, releasing (block 805) a number of the measurement identities to comply with the new value.

In some embodiments, the new value for a maximum number of measurement identities that the secondary node can configure includes one or more of the following: a requested maximum number of allowed measurement identities to configure an inter-frequency measurement; and a requested maximum number of allowed measurement identities to configure an intra-frequency measurement on each serving frequency.

In some embodiments, the new value for a maximum number of measurement identities includes at least one of: an exact number of measurement identities; a maximum number of the measurement identities that the secondary node wants to configure; and an indication that more measurement identities than the prior number of measurement identities configured are requested. The indication includes an indicator of at least one of the requested number of measurement identities is lower than the prior number and the requested number of measurement identities is higher than the prior number.

At block 807, processing circuitry 603 receives an acknowledgement from the master node of the new value for a maximum number of measurement identities.

At block 809, responsive to the acknowledgement, processing circuitry 603 changes a secondary cell group based on applying the new value to a secondary cell group configuration to meet a capability of a communication device.

In some embodiments, the secondary node already has the prior number of measurement identities configured by the master node, and at block 811, processing circuitry 603 receives from the master node the new value for the maximum number of measurement identities.

At block 813, responsive to the receiving, processing circuitry 603 signals a response to the master node that the new value is rejected.

Referring now to FIG. 8B, at block 815, processing circuitry 603 receives from the master node the new value for the maximum number of measurement identities. At block 817, processing circuitry 603, responsive to the receiving, signals a response to the master node with an identification of the measurement identities that are not allocated by the secondary.

At block 819, processing circuitry 603 receives from the master node the new value for the maximum number of measurement identities. Responsive to the receiving, at block 821, processing circuitry 603, signals a response to the master node with the number of the requested measurement identities. At block 623, processing circuitry 823, releases a number of configured measurement identities to meet the new value from the master node.

At block 825, subsequent to signaling the request, processing circuitry 603 triggers a secondary node modification procedure.

At block 827, subsequent to signaling the request, processing circuitry 603 triggers a dual connectivity procedure that involves the change of the secondary cell group configuration.

In some embodiments, the signaling and/or the releasing concerning the maximum number of measurement identities to the master node is via an inter-node radio resource control message.

In some embodiments, the signaling and/or the releasing concerning the maximum number of measurement identities to the master node is via an X2 and/or an Xn signaling.

Various operations from the flow charts of FIGS. 8A-8B may be optional with respect to some embodiments of secondary nodes and related methods. Regarding methods of example embodiment 1 (set forth below), for example, one of the operations of blocks 803 and 805 may be optional operations of blocks 807-827 of FIG. 8 may be optional.

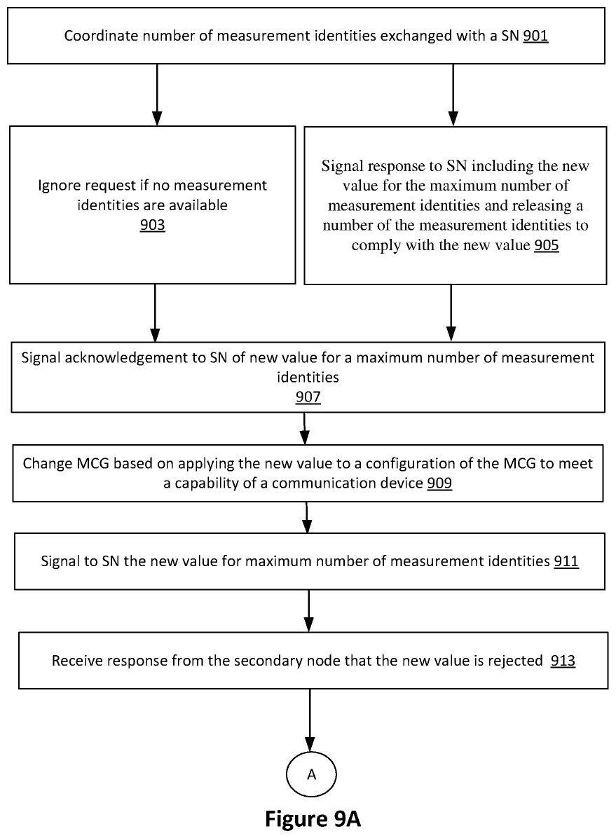

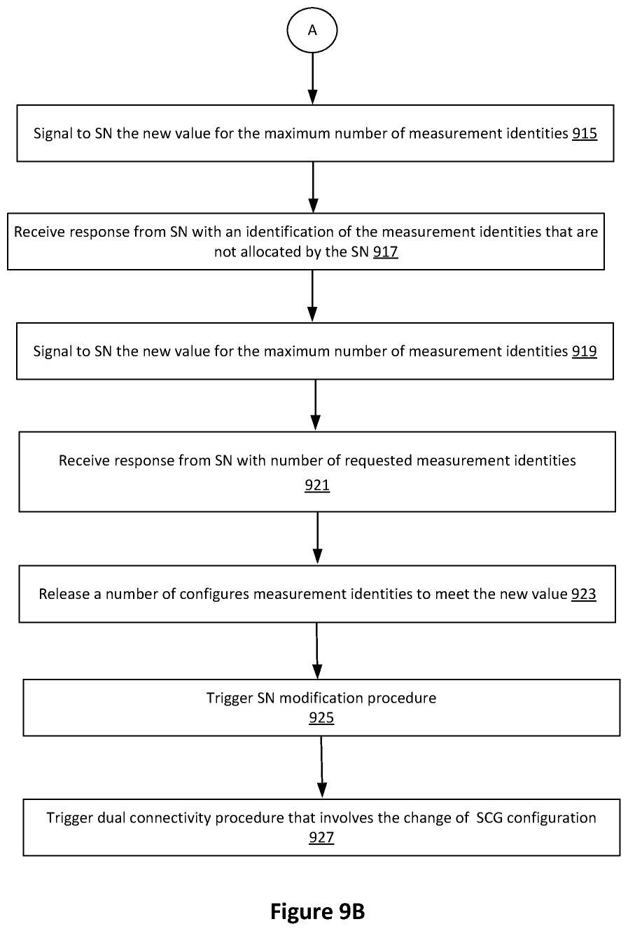

Operations of a master node 207a, 207b (implemented using the structure of FIG. 7) will now be discussed with reference to the flow chart of FIGS. 9A-9B according to some embodiments of the present disclosure. For example, modules may be stored in memory 705 of FIG. 7, and these modules may provide instructions so that when the instructions of a module are executed by respective master node processing circuitry 703, processing circuitry 703 performs respective operations of the flow charts.

Referring initially to FIG. 9A, at block 901, processing circuitry 703 coordinates a number of measurement identities exchanged with a master node. The coordinating includes at least one of the following: receiving a request from the secondary node for a new value for a maximum number of measurement identities that the secondary node can configure when the secondary node wants to allocate additional measurement identities in excess of a prior number of measurement identities configured by the master node.

Responsive to the request, processing circuitry 703, performs at least one of the following: at block 903, ignoring the request if no measurement identities are available; and, at block 905, signaling a response to the secondary node including the new value for the maximum number of measurement identities and releasing a number of the measurement identities to comply with the new value.

In some embodiments, the new value for a maximum number of measurement identities that the secondary node can configure includes one or more of the following: a requested maximum number of allowed measurement identities to configure an inter-frequency measurement; and a requested maximum number of allowed measurement identities to configure an intra-frequency measurement on each serving frequency.

In some embodiments, the new value for a maximum number of measurement identities includes at least one of: an exact number of measurement identities; a maximum number of the measurement identities that the secondary node wants to configure; and an indication that more measurement identities than the prior number of measurement identities configured are requested. The indication includes an indicator of at least one of the requested number of measurement identities is lower than the prior number and the requested number of measurement identities is higher than the prior number.

At block 907, processing circuitry 703 signals an acknowledgement to the secondary node of the new value for a maximum number of measurement identities.

At block 909, subsequent to signaling the acknowledgement, processing circuitry 703 changes a master cell group based on applying the new value to a configuration of the master cell group to meet a capability of a communication device.

In some embodiments, the secondary node already has the prior number of measurement identities configured by the master node, and at block 911, processing circuitry 703 signals to the secondary node the new value for the maximum number of measurement identities.

At block 913, processing circuitry 703 receives a response from the secondary node that the new value is rejected.

Referring now to FIG. 9B, at block 915, processing circuitry 703 signals to the secondary node the new value for the maximum number of measurement identities. At block 917, processing circuitry 703, receives a response from the secondary node with an identification of the measurement identities that are not allocated by the secondary node.

At block 919, processing circuitry 703 signals to the secondary node the new value for the maximum number of measurement identities. At block 921, processing circuitry 703 receives a response from the secondary node with the number of the requested measurement identities. At block 923, processing circuitry 703 releases a number of configured measurement identities to meet the new value.

Subsequent to the signaling of a new value for the maximum number of measurement identities to the secondary node, at block 925, processing circuitry 703, triggers a secondary node modification procedure.

At block 927, subsequent to signaling of a new value for the maximum number of measurement identities to the secondary node, processing circuitry 703, triggers a dual connectivity procedure that involves the change of a secondary cell group configuration.

In some embodiments, the signaling and/or the releasing concerning the maximum number of measurement identities to the secondary node is via an inter-node radio resource control message.

In some embodiments, the signaling and/or the releasing concerning the maximum number of measurement identities to the secondary node is via an X2 and/or an Xn signaling.

Various operations from the flow charts of FIGS. 9A-9B may be optional with respect to some embodiments of secondary nodes and related methods. Regarding methods of example embodiment 12 (set forth below), for example, one of the operations of blocks 903 and 905 may be optional and the operations of blocks 907-927 of FIG. 9 may be optional.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 10 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices. Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units.

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 10 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
3GPP 3rd Generation Partnership Project
5G 5th Generation
CA Carrier Aggregation
CDMA Code Division Multiplexing Access
CP Control Plane
CSI Channel State Information
DC Dual Connectivity
DRX Discontinuous Reception
eNB E-UTRAN NodeB or (EUTRAN) base station
E-UTRA Evolved UTRA
E-UTRAN Evolved UTRAN
FDD Frequency Division Duplex
gNB Base station in NR or NR base station
GSM Global System for Mobile communication
IP Internet Protocol
LPP LTE Positioning Protocol
LTE Long-Term Evolution
MAC Medium Access Control
MCG Master Cell Group
MDT Minimization of Drive Tests
MeNB Master eNB
MgNB Master gNB
MME Mobility Management Entity
MN Master Node
MSC Mobile Switching Center
NR New Radio
OSS Operations Support System
OTDOA Observed Time Difference of Arrival
O&M Operation and Maintenance
PCell Primary Cell
PDCCH Physical Downlink Control Channel
PDCP Packet Data Convergence Protocol
PSCell Primary SCell
RAN Radio Access Network
RAT Radio Access Technology
RLC Radio Link Control
RNC Radio Network Controller
RRC Radio Resource Control
RS Reference Signal
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCell Secondary Cell
SCG Secondary Cell Group
SeNB Secondary eNB
SFN System Frame Number
SINR Signal to Interference plus Noise Radio
SN Secondary Node
SON Self Optimized Network
SRB Signaling Radio Bearer
SS Synchronization Signal
TDD Time Division Duplex
TDOA Time Difference of Arrival
UE User Equipment
UL Uplink
UMTS Universal Mobile Telecommunication System
UP User Plane
UTRA Universal Terrestrial Radio Access
UTRAN Universal Terrestrial Radio Access Network
URLLC Ultra Reliable Low Latency Communication
WCDMA Wide CDMA
WLAN Wide Local Area Network

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a secondary node in a telecommunication network, the method comprising:
coordinating a number of measurement identities exchanged with a master node, wherein the coordinating comprises at least one of the following:
signaling a request to the master node for a new value for a maximum number of measurement identities that the secondary node can configure when the secondary node wants to allocate additional measurement identities in excess of a prior number of measurement identities configured by the master node; and
subsequent to receiving from the master node the new value for the maximum number of measurement identities and wherein the secondary node previously configured the measurement identities based on a prior value for the maximum number measurement identities, releasing a number of the measurement identities to comply with the new value.

2. The method of claim 1, wherein the new value for a maximum number of measurement identities that the secondary node can configure comprises one or more of the following:
a requested maximum number of allowed measurement identities to configure an inter-frequency measurement; and
a requested maximum number of allowed measurement identities to configure an intra-frequency measurement on each serving frequency.

3. The method of claim 1, wherein the new value for a maximum number of measurement identities comprises at least one of:
an exact number of measurement identities;
a maximum number of the measurement identities that the secondary node wants to configure; and
an indication that more measurement identities than the prior number of measurement identities configured are requested, wherein the indication comprises an indicator of at least one of the requested number of measurement identities is lower than the prior number and the requested number of measurement identities is higher than the prior number.

4. The method of claim 1, further comprising:
receiving an acknowledgement from the master node of the new value for a maximum number of measurement identities; and
responsive to the acknowledgement, changing a secondary cell group based on applying the new value to a secondary cell group configuration to meet a capability of a communication device.

5. The method of claim 1, wherein the secondary node already has the prior number of measurement identities configured by the master node, and further comprising:
receiving from the master node the new value for the maximum number of measurement identities; and
responsive to the receiving, signaling a response to the master node that the new value is rejected.

6. The method of claim 1, further comprising:
receiving from the master node the new value for the maximum number of measurement identities; and
responsive to the receiving, signaling a response to the master node with an identification of the measurement identities that are not allocated by the secondary node.

7. The method of claim 1, further comprising:
receiving from the master node the new value for the maximum number of measurement identities;
responsive to the receiving, signaling a response to the master node with the number of the requested measurement identities; and
releasing a number of configured measurement identities to meet the new value from the master node.

8. The method of claim 1, further comprising:
subsequent to signaling the request, triggering a secondary node modification procedure.

9. The method of claim 4, further comprising:
subsequent to signaling the request, triggering a dual connectivity procedure that involves the change of the secondary cell group configuration.

10. The method of claim 1, wherein the signaling and/or the releasing concerning the maximum number of measurement identities to the master node is via an inter-node radio resource control message.

11. The method of claim 1, wherein the signaling and/or the releasing concerning the maximum number of measurement identities to the master node is via an X2 and/or an Xn signaling.

12. A method performed by a master node in a telecommunication network, the method comprising:
coordinating a number of measurement identities exchanged with a secondary node, wherein the coordinating comprises receiving a request from the secondary node for a new value for a maximum number of measurement identities that the secondary node can configure when the secondary node wants to allocate additional measurement identities in excess of a prior number of measurement identities configured by the master node; and
responsive to the request, performing at least one of the following:
ignoring the request if no measurement identities are available; and
signaling a response to the secondary node comprising the new value for the maximum number of measurement identities and releasing a number of the measurement identities to comply with the new value.

13. The method of claim 12, wherein the new value for a maximum number of measurement identities that the secondary node can configure comprises one or more of the following:
a requested maximum number of allowed measurement identities to configure an inter-frequency measurement; and
a requested maximum number of allowed measurement identities to configure an intra-frequency measurement on each serving frequency.

14. The method of claim 12, wherein the new value for a maximum number of measurement identities comprises at least one of:
an exact number of measurement identities;
a maximum number of the measurement identities that the secondary node wants to configure; and
an indication that more measurement identities than the prior number of measurement identities configured are requested, wherein the indication comprises an indicator of at least one of the requested number of measurement identities is lower than the prior number and the requested number of measurement identities is higher than the prior number.

15. The method of claim 12, further comprising:
signaling an acknowledgement to the secondary node of the new value for a maximum number of measurement identities; and
subsequent to signaling the acknowledgement, changing a master cell group based on applying the new value to a configuration of the master cell group to meet a capability of a communication device.

16. The method of claim 12, wherein the secondary node already has the prior number of measurement identities configured by the master node, and further comprising:
signaling to the secondary node the new value for the maximum number of measurement identities; and
receiving a response from the secondary node that the new value is rejected.

17. The method of claim 12, further comprising:
signaling to the secondary node the new value for the maximum number of measurement identities; and
receiving a response from the secondary node with an identification of the measurement identities that are not allocated by the secondary node.

18. The method of claim 12, further comprising:
signaling to the secondary node the new value for the maximum number of measurement identities;
receiving a response from the secondary node with the number of the requested measurement identities; and
releasing a number of configured measurement identities to meet the new value.

19. The method of claim 12, further comprising:
subsequent to the signaling of a new value for the maximum number of measurement identities to the secondary node, triggering a secondary node modification procedure.

20. The method of claim 15, further comprising:
subsequent to signaling of a new value for the maximum number of measurement identities to the secondary node, triggering a dual connectivity procedure that involves the change of a secondary cell group configuration.

21. The method of claim 12, wherein the signaling and/or the releasing concerning the maximum number of measurement identities to the secondary node is via an inter-node radio resource control message.

22. The method of claim 12, wherein the signaling and/or the releasing concerning the maximum number of measurement identities to the secondary node is via an X2 and/or an Xn signaling.

23. A secondary node in a telecommunication network, the secondary node comprising:
processing circuitry;
memory coupled with the processing circuitry, wherein the memory includes instructions that when executed by the processing circuitry causes the secondary node to:
coordinate a number of measurement identities exchanged with a master node, wherein the coordinate comprises at least one of the following:
signal a request to the master node for a new value for a maximum number of measurement identities that the secondary node can configure when the secondary node wants to allocate additional measurement identities in excess of a prior number of measurement identities configured by the master node; and
subsequent to receiving from the master node the new value for the maximum number of measurement identities and wherein the secondary node previously configured the measurement identities based on a prior value for the maximum number measurement identities, release a number of the measurement identities to comply with the new value.

24. The secondary node of claim 23, wherein the new value for a maximum number of measurement identities that the secondary node can configure comprises one or more of the following:
a requested maximum number of allowed measurement identities to configure an inter-frequency measurement; and
a requested maximum number of allowed measurement identities to configure an intra-frequency measurement on each serving frequency.

25. (canceled)

26. A master node in a telecommunication network, the master node comprising:
processing circuitry;
memory coupled with the processing circuitry, wherein the memory includes instructions that when executed by the processing circuitry causes the master node to:
coordinate a number of measurement identities exchanged with a secondary node, wherein the coordinate comprises receiving a request from the secondary node for a new value for a maximum number of measurement identities that the secondary node can configure when the secondary node wants to allocate additional measurement identities in excess of a prior number of measurement identities configured by the master node; and
responsive to the request, perform at least one of the following:
ignore the request if no measurement identities are available; and
signal a response to the secondary node comprising the new value for the maximum number of measurement identities and releasing a number of the measurement identities to comply with the new value.

27. The master node of claim 26, wherein the new value for a maximum number of measurement identities that the secondary node can configure comprises one or more of the following:
a requested maximum number of allowed measurement identities to configure an inter-frequency measurement; and
a requested maximum number of allowed measurement identities to configure an intra-frequency measurement on each serving frequency.

28-36. (canceled)
